(19) United States
(12) Patent Application Publication
(10) Pub. No.: US 2024/0071343 A1
(43) Pub. Date: Feb. 29, 2024

(54) SYSTEMS AND METHODS FOR TRANSPOSING SPOKEN OR TEXTUAL INPUT TO MUSIC

(71) Applicant: RIFFIT INC, Plymouth, MA (US)

(72) Inventors: Leonardus H.T. Van Der Ploeg, Newton, MA (US); Deepak Savadatti, Los Altos, CA (US)

(21) Appl. No.: 18/272,175

(22) PCT Filed: Jan. 13, 2022
(86) PCT No.: PCT/US2022/012331

§ 371 Date: Jul. 13, 2023

Related U.S. Application Data
(60) Provisional application No. 63/136,698, filed on Jan. 13, 2021.

(51) Int. Cl. G10H 1/00; G10L 13/06; G10L 13/10

(52) U.S. Cl. CPC G10H 1/0025; G10L 13/06; G10L 13/10; G10H 2210/056; G10H 2210/111; G10H 2250/455; G10L 2013/105

(57) ABSTRACT

Described herein are musical translation devices and methods of use thereof. Exemplary uses of musical translation devices include optimizing the understanding and/or recall of an input message for a user and improving a cognitive process in a user.

### CROSS-REFERENCE TO RELATED APPLICATIONS

This application claims priority under 35 U.S.C. § 119(e) to U.S. Provisional Application Ser. No. 63/136,698, titled “SYSTEMS AND METHODS FOR TRANSPOSING SPOKEN OR TEXTUAL INPUT TO MUSIC,” filed on Jan. 13, 2021, which is hereby incorporated by reference in its entirety.

### TECHNICAL FIELD

The present disclosure is directed to systems and methods for transposing spoken or textual input to music.

### BACKGROUND

For millennia, humans have used music, and in particular vocal songs and melodies, to convey information in a manner that heightens interest and facilitates comprehension and long-term recall of the information conveyed. The timing and variations in pitch and rhythm in a song may signal to the listener what information is important and how different concepts in the text are related to each other, causing the listener to retain and understand more of the information than if it was merely spoken. The unique ability of song to convey information that is distinctly processed by the brain from non-musical spoken words is supported by brain imaging results which have shown that different patterns of brain activity occur for spoken words when compared to words in song. The findings highlighting unique cognitive processing of words in song, are supported by applications where, in addition to their entertainment value, songs may be taught to children to assist with learning and remembering the number of days in a month, the states and their capitals, or other pieces of information that may otherwise elude understanding or memory retention.

Separately, but relatedly, persons with a cognitive impairment, behavioral impairment, or learning impairment may find it easier to comprehend and recall information when conveyed as a song or melody. For example, a passage of text read in a normal speaking tone by the student or an instructor may not be comprehended or recalled, whereas the same passage of text when sung may be more easily comprehended and recalled by persons having impairments including, for example, a neurological or behavioral impairment (e.g., dyslexia, aphasia, autism spectrum disorder, Alzheimer's disease, dementia, Down's syndrome, Prader Willi syndrome, Smith Magenis syndrome, a learning disability, an intellectual disability, Parkinson's disease, anxiety, stress, schizophrenia, brain surgery, surgery, stroke, trauma, or other neurological or behavioral disorder). Exposure to information “coded” in music is anticipated to lead, over the long term, to enhanced verbal IQ, quantitative measures of language comprehension, and quantitative measures of the ability to interact with care providers.

While users with selected clinical impairments may benefit from information being sung, the general population of instructors, care providers, teachers and the like may not have the capability or willingness to sing the information to be conveyed. Even if instructors do have such willingness and skills, transforming text or voice to a musical score takes time and effort if word recognition and comprehension are to be optimally retained. Furthermore, for the case of voice, the instructor's physical presence could be required for the voice to be heard. In addition, different individuals and/or different disorders may respond to different styles and natures of music (i.e., genre, tempo, rhythm, intervals, key, chord structure, song structure), meaning that even for a given passage of information, a one-size-fits-all approach may be inadequate.

### SUMMARY

A device and/or software are provided for receiving input (e.g., a textual, audio, or visual, message) containing information to be conveyed, and converting that input to a patterned musical message, such as a melody, intended to facilitate a learning or cognitive process of a user. The musical message may be output in real-time, near-real time, and/or non-real-time (for example, created in real-time with respect to a user input being received, but being played back at a later time). In some examples described here, the application and device are described as a dedicated Musical Translation Device (MTD), wherein “device” should be understood to refer to a system that incorporates hardware and software components, such as mobile applications. In various examples, an MTD may be a non-dedicated device, application, or service, such as a laptop computer, tablet computer, smartphone, desktop computer, digital assistant, e-mail application, and so forth, configured to perform operations in addition to musical translation. In some embodiments, an MTD is an application accessed on a smartphone, desktop computer, laptop computer, or tablet computer.

Devices disclosed herein may operate in real-time, near-real-time, and/or non-real-time. As used herein, “real-time” and “near-real-time” operation of a device refer to a temporal relationship between generating a musical message and playing back the musical message (for example, outputting as an acoustic signal perceivable by an individual) rather than a temporal relationship between receiving a user input (for example, an audio input, a text input, a graphical input, and so forth) and generating a musical message. In other examples, however, “real-time” and “near-real-time” may refer to a temporal relationship between receiving a user input and generating a musical message in addition to, or in lieu of, a temporal relationship between generating a musical message and playing back the musical message. As used herein, “non-real-time” operation of a device refers to a situation in which a message is generated and/or stored (where the generation and/or storage may be performed in real-time with receipt of a user input even if the device is operating in “non-real-time” operation) without outputting the message (for example, as an audible acoustic signal) substantially immediately thereafter, which is considered “non-real-time” inasmuch as a non-negligible delay is intentionally instituted between generating the musical message and playing back the musical message. For example, the message may be generated and stored, and may not be played back until a user (who may be a user other than a user that generated the message) specifically selects the message for playback, or meets one or more other criteria for having the message played aloud. That is, operation may be considered “non-real-time” because one or more criteria are to be met before playing the message aloud, rather than because of a particular length of time elapsing between generating the musical message and playing back the musical message. Similarly, operation may be considered “real-time” or “non-real-time” because a musical message is played aloud after generating the musical message without one or more additional criteria needing to be met. In some examples, a device may send a generated musical message to another, receiving device configured to store the received musical message and play the stored, received musical message to a user of the receiving device. For example, the user of the receiving device may select the received message for playback, responsive to which the receiving device may generate an acoustic signal for playback to the user based on the received message.

In still other examples, the application may also be performed on other audio-input and -output capable devices, including a mobile device such as a smart phone, tablet, laptop computer, and the like, that has been specially programmed. In some examples, the application may be performed in connection with multiple devices, including a transmitting device and a receiving device.

A device may allow the user to have some control and/or selection regarding the musical themes that are preferred or that can be chosen. For example, a user may be presented with a list of musical genres, moods, styles, or tempos, and allowed to filter the list of songs according to the user's selection, which will be taken to transfer routine spoken words or text to the musical theme, in real, near-real time, or non-real-time. The user may be a user of a device that generates or receives a patterned musical message for playback. In another example, the user may identify one or more disorders that the patterned musical message is intended to be adapted for, and the device may select a genre and/or song optimized for that disorder. In yet another example, a user may be “prescribed,” by a medical care provider, a genre suitable for treating the user's disorder. It will be appreciated that as used herein, “genre” is intended to encompass different musical styles and traditions originating from different time periods, locations, or cultural groups, as well as systematic differences between artists within a given time period. Genres may include, for example, rock, pop, R&B, hip-hop, rap, country, nursery rhymes, or traditional music such as Gregorian chants or Jewish Psalm tones, as well as melodies fitting a particular class of tempo (“slow”, “medium”, or “fast”), mood (“cheerful”, “sad”, etc.), or predominant scale (“major” or “minor”) or other quantifiable musical property. User preferences, requirements, and diagnoses may be learned and stored by the device, such that an appropriate song or genre may be suggested and/or selected by the device in an intuitive and helpful manner. In some examples, user preferences, requirements, and/or diagnoses may be learned and stored by a first device that receives a message generated by a second device, and/or may be learned and stored by the second device that generates the message for playback by the first device. In some embodiments, machine learning and/or artificial intelligence algorithms may be applied to enable the device(s) to learn, predict, and/or adapt to user preferences, requirements, and diagnoses including collecting and applying user-data that describe a user's physiological condition including heart rate, eye movements, breathing, muscle-tone, movement, pharmacodynamic markers of device efficacy, and so forth.

In some embodiments, the selections regarding genre and/or disorder may be used to match portions of a timed text input (for example, the text input and associated timing information, as discussed in greater detail below) to appropriate melody segments in order to generate a patterned musical message.

It will be appreciated that while the patterned musical message generated and output by the device is referred to here as a “melody” for the sake of simplicity, the patterned musical message is not necessarily a melody as defined in musical theory, but may be any component of a piece of music that when presented in a given musical context is musically satisfying and/or that facilitates word or syntax comprehension or memory, including rhythm, harmony, counterpoint, descant, chant, particular spoken cadence (e.g., beat poetry), or the like, as exemplified in rhythmic training, phonemic sound training or general music training for children with dyslexia. It will also be appreciated that the musical pattern may comprise an entire song, one or more passages of the song, or simply a few measures of music, such as the refrain or “hook” of a song. More generally, music may be thought of in this context as the melodic transformation of spoken language or text to known and new musical themes by ordering tones and sounds in succession, in combination, and in temporal relationships to produce a composition having unity and continuity. Relevant indications benefitting from the device include, for example, dyslexia, aphasia, autism spectrum disorder, Alzheimer's disease, dementia, Down's syndrome, Prader Willi syndrome, Smith Magenis syndrome, learning disability, an intellectual disability, Parkinson's disease, anxiety, stress, schizophrenia, brain surgery, surgery, stroke, trauma, or other neurological or behavioral disorder. For instance, in cases of stroke causing lesion to the left-hemisphere, particularly near language-related areas such as Broca's area, any patterning that leads to a more musical output, including all musical or prosodic components above, may lead to increased ability to rely on intact right-hemisphere function to attain comprehension. In the case of dyslexia, any one of these added musical dimensions to the text may provide alternative pathways for comprehension.

According to some embodiments, recognition and/or comprehension of the words presented in song can be over 95%, or over 99%, or over 99.5%, or over 99.9% using the methods and/or devices described herein. It will be appreciated that any significant improvement in comprehension can lead to significant improvements of quality of life in cases such as post-stroke aphasia, where patients will need to communicate with their caretakers and other individuals, in dyslexia, where individuals may be able to struggle less in educational settings, or for any of the above indications where quality of life is hindered by the inability to communicate or attain information through spoken or textual sources.

While scenarios involving an “instructor” and a “student” are described here for clarity purposes, it should be understood that the term “user” of the device, as referred to herein, encompasses any individual that may use the device, such as a patient, an instructor, a teacher, a physician, a nurse, a therapist, a student, a parent or guardian of said student, a care provider, a consumer, an individual operating a messaging account such as an e-mail account, and so forth. A user of the device may or may also be referred to herein as a “subject.” A user may be a child or an adult, and may be either male or female. In an embodiment, the user is a child, e.g., an individual 18 years of age or younger. In an embodiment, the user may have an indication described herein, such as a learning disability, Alzheimer's disease, or may be recovering from a stroke. Further, as the treatable conditions discussed herein are referred to generally as “disorders,” it is to be appreciated that the device may be used to treat disabilities, afflictions, symptoms, or other conditions not technically categorized as disorders or the device may be used to facilitate general understanding and comprehension of routine conversation by the general public.

It is also to be appreciated that translation of information to patterned musical messages may benefit typically developing/developed users as well as those with a disorder or other condition, e.g., as described. Furthermore, the translation of spoken or textual language to music made possible by these systems and methods provide advantages beyond the therapeutic uses discussed here. For example, the device may be used for musical or other entertainment purposes, including music instruction or games, messaging applications (for example, e-mail, text messaging, and so forth), advertising, and so forth.

According to various examples, a method of transforming textual input to a musical score is provided comprising receiving, by a first device, text input, transliterating the text input into a standardized phonemic representation of the text input, determining, for the phonemic text input, a plurality of spoken pause lengths and a plurality of spoken phoneme lengths, mapping the plurality of spoken pause lengths to a respective plurality of sung pause lengths, mapping the plurality of spoken phoneme lengths to a respective plurality of sung phoneme lengths, generating, from the plurality of sung pause lengths and the plurality of sung phoneme lengths, a timed text input, and transmitting, by the first device, message information including the timed text input to a second device such that the second device outputs a patterned musical message indicative of the text input based on the message information.

In various examples, the method includes generating, by the first device, a plurality of matching metrics for each of a respective plurality of portions of the timed text input against a plurality of melody segments, wherein the message information includes the plurality of matching metrics. In some examples, the method includes generating, by the first device, the patterned musical message from the timed text input and the plurality of melody segments based at least in part on the plurality of matching metrics, wherein the message information includes the patterned musical message. In at least one example, the method includes generating, by the second device, a plurality of matching metrics for each of a respective plurality of portions of the timed text input against a plurality of melody segments based on the message information. In various examples, the method includes generating, by the second device, the patterned musical message from the timed text input and the plurality of melody segments based at least in part on the plurality of matching metrics.

In some examples, the method includes determining, by the second device, at least one of a preference, requirement, or specification of a user of the second device. In at least one example, the method includes generating a plurality of matching metrics for each of a respective plurality of portions of the timed text input against a plurality of melody segments based on the message information and the at least one of the preference, requirement, or specification of the user of the second device. In various examples, the method includes generating, by the second device, the patterned musical message from the timed text input based at least in part on the plurality of melody segments. In some examples, the method includes determining, by the first device, at least one of a preference, requirement, or specification of a user of the first device. In at least one example, the method includes generating a plurality of matching metrics for each of a respective plurality of portions of the timed text input against a plurality of melody segments based on the at least one of the preference, requirement, or specification of the user of the first device.

In various examples, the method includes generating the patterned musical message from the timed text input based at least in part on the plurality of melody segments. In some examples, receiving the text input includes receiving an electronic message including the text input. In at least one example, the electronic message is an e-mail message. In various examples, receiving the text input includes receiving an advertisement comprising the text input. In some examples, the method includes storing, by the second device, the patterned musical message. In at least one example, the method is performed in non-real-time, and further comprises causing the patterned musical message to be played audibly on a transducer. In various examples, the patterned musical message is presented to a user having a cognitive impairment, a behavioral impairment, or a learning impairment.

In some examples, the user has a comprehension disorder, including at least one of autism spectrum disorder, attention deficit disorder, attention deficit hyperactivity disorder, aphasia, dementia, dyspraxia, dyslexia, dysphasia, apraxia, stroke, traumatic brain injury, brain surgery, surgery, schizophrenia, schizoaffective disorder, depression, bipolar disorder, post-traumatic stress disorder, Alzheimer's disease, Parkinson's disease, age-related cognitive impairment, a language comprehension impairment, an intellectual disorder, a developmental disorder, stress, anxiety, Williams syndrome, Prader Willi syndrome, Smith Magenis syndrome, Bardet Biedl syndrome, Down's syndrome, or other neurological disorders.

According to at least one example, a musical translation device system includes a first device comprising an input interface, a first processor, a first communication interface, and a first memory communicatively coupled to the first processor and comprising instructions that when executed by the first processor cause the first processor to receive a text input at the input interface, transliterate the text input into a standardized phonemic representation of the text input, determine, for the phonemic text input, a plurality of spoken pause lengths and a plurality of spoken phoneme lengths, map the plurality of spoken pause lengths to a respective plurality of sung pause lengths, map the plurality of spoken phoneme lengths to a respective plurality of sung phoneme lengths, generate, from the plurality of sung pause lengths and the plurality of sung phoneme lengths, a timed text input, and transmit, via the first communication interface, message information including the timed text input, and a second device comprising a second processor, a second communication interface, a transducer, and a second memory communicatively coupled to the second processor and comprising instructions that when executed by the second processor cause the second processor to receive, at the second communication interface, the timed text input, and output, by the transducer, a patterned musical message based on the timed text input.

According to at least one example, a non-transitory computer-readable medium storing thereon sequences of computer-executable instructions for operating a first device is provided, the sequences of computer-executable instructions including instructions that instruct at least one processor to receive a text input, transliterate the text input into a standardized phonemic representation of the text input, determine, for the phonemic text input, a plurality of spoken pause lengths and a plurality of spoken phoneme lengths, map the plurality of spoken pause lengths to a respective plurality of sung pause lengths, map the plurality of spoken phoneme lengths to a respective plurality of sung phoneme lengths, generate, from the plurality of sung pause lengths and the plurality of sung phoneme lengths, a timed text input, and transmit, by the first device, message information including the timed text input to a second device such that the second device outputs a patterned musical message indicative of the text input based on the message information.

According to at least one example, a method of transforming textual input to a musical score is provided comprising receiving, by a first device, text input, mapping the text input to a sung input, generating, from the sung input, a timed text input, and transmitting, by the first device, message information including the timed text input to a second device such that the second device outputs a patterned musical message indicative of the text input based on the message information.

According to at least one example, a method of transforming textual input to a musical score is provided comprising receiving, by a first device, text input, generating, based on the text input, a timed text input, generating a plurality of matching metrics for each of a respective plurality of portions of the timed text input against a plurality of melody segments, generating a patterned musical message from the timed text input and the plurality of melody segments based at least in part on the plurality of matching metrics, and transmitting, by the first device, message information including the timed text input to a second device such that the second device outputs the patterned musical message indicative of the text input based on the message information.

The details of one or more embodiments of the invention are set forth herein. Other features, objects, and advantages of the invention will be apparent from the Detailed Description, the Figures, the Examples, and the Claims.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a functional block diagram of a musical translation device (MTD) according to one embodiment;

FIG. 2A depicts a process for operating the application and/or a device according to one embodiment;

FIG. 2B depicts a process for operating the application and/or a device according to one embodiment;

FIG. 3 depicts an exemplary user interface according to one embodiment;

FIG. 4 depicts a process for operating the application and/or a device according to one embodiment;

FIG. 5 depicts an exemplary user interface according to one embodiment;

FIG. 6 depicts a swim-lane diagram of a process for outputting a patterned musical message;

FIG. 7 shows an example computer system with which various aspects of the present disclosure may be practiced;

FIG. 8 shows an example storage system capable of implementing various aspects of the present disclosure;

FIG. 9 depicts an exemplary multiple-device system according to one embodiment; and

FIG. 10 depicts a process of generating a sung message according to an example.

### DETAILED DESCRIPTION

As discussed above, examples include devices configured to generate and/or play back one or more musical messages. A device may be capable of generating and playing back musical messages in real-time, near-real-time, and/or non-real-time. It is to be appreciated that a device may be capable of operating in one or more modes, including a real-time mode, a near-real-time mode, and a non-real-time mode. Furthermore, a device may perform operations in multiple modes of operation, such as by outputting a patterned musical message in real- or near-real-time and, in addition, storing the patterned musical message for later playback, and/or transmitting the patterned musical message to one or more other devices for storage or playback.

As used herein, a “real-time musical translation device” (RETM) may refer to a device capable of generating and playing back musical messages in real-time or near-real-time. In some examples, an RETM may additionally be capable of storing musical messages for later playback in non-real-time and/or transmitting the musical message to a second, receiving device for later playback by a user of the second, receiving device. That is, an RETM may be capable of operating in non-real-time as well as real-time and/or near-real-time. In other examples, an RETM may only refer to a device that is capable of generating and playing back musical messages in real-time or near-real-time.

As used herein, a “non-real-time musical translation device” (NRETM) may refer to a device capable of generating musical messages and storing or transmitting the musical messages for later, non-real-time playback. In some examples, an NRETM may generate a musical message in real-time as a user input is received, or in non-real-time at a non-negligible time after the user input is received, store the musical message in local storage and/or memory, and later generate one or more acoustic signals for playback to a user based on the stored musical message in non-real-time. In various examples, an NRETM may generate a musical message and transmit the musical message to a second, receiving device for later playback by a user of the second, receiving device. In at least one example, such a second, receiving device may be an NRETM, where said NRETM may be capable of receiving, storing, and playing back a musical message, and may or may not be capable of generating a musical message itself.

As used herein, a “musical translation device,” “MTD,” or simply “device” may refer to an RETM or an NRETM.

### Musical Translation Device

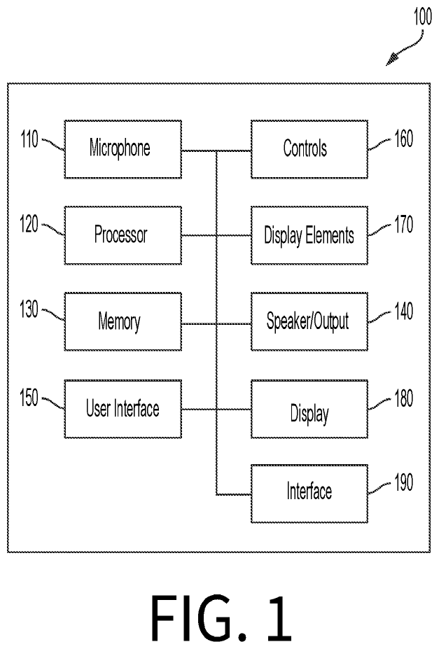

A block diagram of an exemplary musical translation device (MTD) 100 is shown in FIG. 1. As discussed in greater detail below, in some examples, musical translation devices may operate in real-time, near-real-time, and/or non-real-time. The MTD 100 may include a microphone 110 for receiving an audio input (e.g., spoken information) from a user, and may also be configured to receive voice commands for operating the MTD 100 from the user via the microphone. A processor 120 and a memory 130 are in communication with each other and the microphone to receive, process through selected algorithms and code, and/or store the audio input or information or signals derived therefrom, and ultimately to generate the patterned musical message. A user interface 150, along with controls 160 and display elements 170, allow a user to interact with the MTD 100 (e.g., by picking a song to use as a basis for generating the patterned musical message). A speaker or other output 140 may act as a transducer (i.e., convert the patterned musical message to an audio signal) or may provide the patterned musical message device to another device (e.g., headphones or an external speaker). Optionally, a display device 180 may display visual and/or textual information designed to reinforce and/or complement the patterned musical message. An interface 190 allows the MTD 100 to communicate with other devices, including through local connection (e.g., Bluetooth) or through a LAN or WAN (e.g., the Internet).

The microphone 110 may be integrated into the MTD 100, or may be an external and/or separately connectable microphone, and may have any suitable design or response characteristics. For example, the microphone 110 may be a large diaphragm condenser microphone, a small diaphragm condenser microphone, a dynamic microphone, a bass microphone, a ribbon microphone, a multi-pattern microphone, a USB microphone, or a boundary microphone. In some examples, more than one microphone may be deployed in an array. In some embodiments, the microphone 110 may not be provided (or if present may not be used), with audio input received from an audio line in (e.g., AUX input), or via a wired or wireless connection (e.g., Bluetooth) to another device.

The processor 120 and/or other components may include functionality or hardware for enhancing and processing audio signals, including, for example, signal amplification, analog-to-digital conversion/digital audio sampling, echo cancellation, audio mastering, or other audio processing, etc., which may be applied to input from the microphone 110 and/or output to the speaker 140 of the MTD 100. As discussed in more detail below, the MTD 100 may employ pitch- and time-shifting on the audio input, with reference to a score and/or one or more rules, in order to convert a spoken message into the patterned musical message.

The memory 130 is non-volatile and non-transitory and may store executable code for an operating system that, when executed by the processor 120, provides an application layer (or user space), libraries (also referred to herein as “application programming interfaces” or “APIs”) and a kernel. The memory 130 also stores executable code for various applications, including the processes and sub-processes described here. Other applications may include, but are not limited to, a web browser, email client, calendar application, etc. The memory may also store various text files and audio files, such as, but not limited to, text to be converted to a patterned musical message; a score or other notation, or rules, for the patterned musical message; raw or processed audio captured from the microphone 110; the patterned musical message itself; and user profiles or preferences. Melodies may be selected and culled according to their suitability for optimal text acceptance. This selection may be made by a human (e.g., the user or an instructor) and/or automatically by the MTD or other computing device, such as by using a heuristic algorithm.

The source or original score may be modified to optimally become aligned with voice and/or text, leading to the generated score, which, includes the vocal line, is presented by the synthesized voice and presents the text as lyrics. The generated score, i.e. the musical output of the MTD, may include pitch and duration information for each note and rest in the score, as well as information about the structure of the composition represented by the generated score, including any repeated passages, key and time signature, and timestamps of important motives. The generated score may also include information regarding other parts of the composition not included in the patterned musical message. The score may include backing track information or may provide a link to a prerecorded backing track and/or accompaniment. For example, the MTD 100 may perform a backing track along with the patterned musical message, such as by simulating drums, piano, backing vocals, or other aspects of the composition or its performance. In some embodiments, the backing track may be one or more short segments that can be looped for the duration of the patterned musical message. In some examples, the score is stored and presented according to a technical standard for describing event messages, such as the Musical Instrument Digital Interface (MIDI) standard. Data in the score may specify the instructions for music, including a note's notation, pitch, velocity, vibrato, and timing/tempo information.

A user interface 150 may allow the user to interact with the MTD 100. For example, the user (e.g., instructor or student) may use user interface 150 to select a song or genre used in generating the patterned musical message, or to display text that the user may read to provide the audio input. Other controls 160 may also be provided, such as physical or virtual buttons, capacitive sensors, switches, or the like, for controlling the state and function of the MTD 100. Similarly, display elements 170 may include LED lights or other indicators suitable for indicating information about the state or function of the MTD 100, including, for example, whether the MTD 100 is powered on, whether it is currently receiving audio input or playing back the patterned musical message. Such information may also be conveyed by the user interface 150. Tones or other audible signals may also be generated by the MTD 100 to indicate such state changes.

The user interface 150 allows one or more users to select a musical pattern and/or ruleset as discussed herein. In some examples, different users may have different abilities to control the operation of the MTD 100 using the user interface 150. For example, whereas a first user (e.g., an instructor) may be allowed to select a disorder, a genre, and/or a song, a second user (e.g., a student) may be constrained to choosing a particular song within a genre and/or set of songs of songs classified for a particular disorder by the first user or otherwise. In this manner, a first user can exercise musical preferences within a subset of musical selections useful for treating a second user. In an embodiment, a first user can exercise musical preferences within a subset of musical selection useful for treating a plurality of users, such as a second user, a third user, or a fourth user.

In some examples, the user may interact with the MTD 100 using other interfaces in addition to, or in place of, user interface 150. For example, the MTD 100 may allow for voice control of the device (“use ‘rock & roll’”), and may employ one or more wake-words allowing the user to indicate that the MTD 100 should prepare to receive such a voice command.

The display 180 may also be provided, either separately or as part of the user interface 150, for displaying visual or textual information that reinforces and/or complements the information content of the text or voice or spoken words of the patterned musical message. In some embodiments, the display 180 may be presented on an immersive device such as a virtual reality (VR) or augmented reality (AR) headset.

The interface 190 allows the MTD 100 to communicate with other devices and systems. In some embodiments, the MTD 100 has a pre-stored set of data (e.g., scores and backing tracks); other embodiments, the MTD 100 communicates with other devices or systems in real time to process audio and/or generate the patterned musical message. Communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

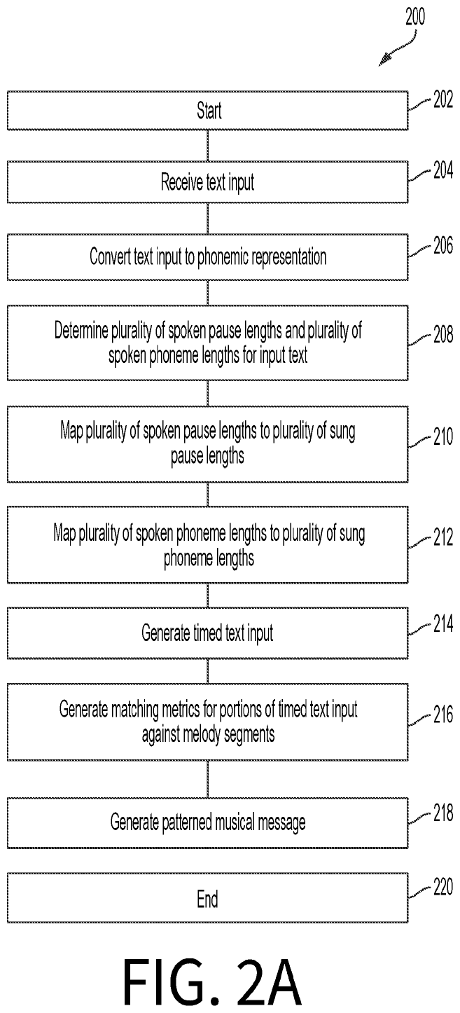

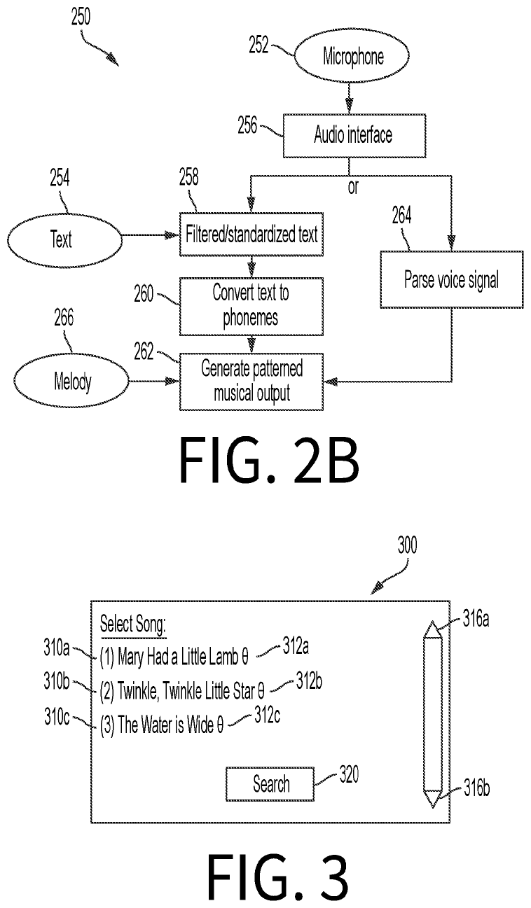

A method 200 of transposing spoken or textual input to a patterned musical message is shown in FIG. 2A.

At step 202, the method begins.

At step 204, text input is received. Text input may be received, for example, by accessing a text file or other computer file such as an image or photo, in which the text is stored. The text may be formatted or unformatted. The text may be received via a wired or wireless connection over a network, or may be provided on a memory disk. In other embodiments, the text may be typed or copy-and-pasted directly into a device by a user. In still other embodiments, the text may be obtained by capturing an image of text and performing optical character recognition (OCR) on the image. The text may be arranged into sentences, paragraphs, and/or larger subunits of a larger work.

At step 206, the text input is converted into a phonemic representation, as can be represented by any standard format such as ARPABET, IPA or SAMPA. This may be accomplished, in whole or in part, using free or open source software, such as Phonemizer, and/or the Festival Speech Synthesis System developed and maintained by the Centre for Speech Technology Research at the University of Edinburgh. However, in addition certain phonemes in certain conditions (e.g., surrounded by other phonemes) are to be modified so as to be better comprehended as song. The phonemic content may be deduced by a lookup table mapping (spoken phoneme, spoken phoneme surroundings) to (sung phoneme). In some cases the entire preceding or consequent phoneme is taken into account when determining a given phoneme, while in other cases only the onset or end of the phoneme is considered.

In some examples, a series of filters may be applied to the text input to standardize or optimize the text input. For example, filters may be applied to convert abbreviations, currency signs, and other standard shorthand to text more suited for conversion to speech.

At step 208, a plurality of spoken pause lengths and a plurality of spoken phoneme lengths are determined for the text input. The length of the pauses and the phonemes represented in the text input may be determined with the help of open source software or other sources of information regarding the prosodic, syntactic, and semantic features of the text or voice. The process may involve a lookup table that synthesizes duration information about phonemes and pauses between syllables, words, sentences, and other units from other sources which describe normal speech. In some examples, the spoken length of phonemes may be determined and/or categorized according to their position in a larger syntactic unit (e.g., a word or sentence), their part of speech, or their meaning. In some examples, a dictionary-like reference may provide a phoneme length for specific phonemes and degrees of accent. For example, some phonemes may be categorized as having a phoneme length of less than 0.1 seconds, less than 0.2 seconds, less than 0.3 seconds, less than 0.4 seconds, or less than 1.0 seconds. Similarly, some pauses may be categorized according to their length during natural spoken speech, based upon their position within the text or a subunit thereof, the nature of phonemes and/or punctuation nearby in the text; or other factors.

At step 210, the plurality of spoken pause lengths is mapped to a respective plurality of sung pause lengths. For example, a Level 1 spoken pause (as discussed above) in spoken text may be mapped to a Level 1 sung pause, which may have a longer or shorter duration than the corresponding spoken pause. In some examples, any Level 1 spoken pause may be mapped to an acceptable range of Level 1 sung pauses. For example, a Level 1 spoken pause may be mapped to a range of Level 1 sung pauses of between 0.015 to 0.08 seconds or between 0.03 to 0.06 seconds. Similarly, a Level 2 spoken pause may be mapped to a sung pause of between 0.02 to 0.12 seconds or between 0.035 to 0.1 seconds. A Level 3 spoken pause may be mapped to a sung pause of between 0.05 to 0.5 seconds or between 0.1 to 0.3 seconds; and a Level 4 spoken pause may be mapped to a sung pause of between 0.3 to 1.5 seconds or between 0.5 to 1.0 seconds.

At step 212, the plurality of spoken phoneme lengths is mapped to a respective plurality of sung phoneme lengths. The mapping may represent, for a spoken phoneme of a given length, a range of optimal lengths for the phoneme when sung. In some examples, a lookup table may be used, such as the following:

| | |
|---|---|
| Spoken Phoneme Length | Optimal Sung Phoneme Length |

| | | |
|---|---|---|
| <0.1 | seconds | 0.1 to 0.5 seconds |
| <0.2 | seconds | 0.3 to 0.7 seconds |
| <0.3 | seconds | 0.35 to 0.8 seconds |
| >=0.3 | seconds | 0.4 to 0.9 seconds |

In another example, a broader range of values may be used:

| | |
|---|---|
| Spoken Phoneme Length | Optimal Sung Phoneme Length |

| | | |
|---|---|---|
| <0.1 | seconds | 0.05 to 0.7 seconds |
| <0.2 | seconds | 0.2 to 0.9 seconds |
| <0.3 | seconds | 0.3 to 1.0 seconds |
| >=0.3 | seconds | 0.35 to 1.5 seconds |

It will be appreciated that the plurality of spoken pause lengths and the plurality of spoken phoneme lengths applied in steps 210 and 212, respectively, may be determined with reference to one or more parameters. Those parameters may include optimal breaks between sentences, optimal tempo, optimal time signature, optimal pitch range, and optimal length of phonemes, where optimality is measured with respect to facilitating comprehension and/or recollection. In some cases, a number of these factors may be applied, possibly with relative weights, in mapping the plurality of spoken pause lengths and the plurality of spoken phoneme lengths.

Certain constraints may be imposed on the plurality of spoken pause lengths and the plurality of spoken phoneme lengths. In particular, spoken pause lengths and spoken phoneme lengths determined in the previous steps may be adjusted according to certain constraints in order to optimize comprehension and musicality. The constraints may be set based on the frequency/commonality of the word, or on its position within a sentence or clause, such as a “stop” word. For example, a constraint may be enforced that all phonemes in stop words must have a length of <=0.6 seconds. A stop word, as used herein, may be natural language words which have very little meaning, such as “and”, “the”, “a”, “an”, and similar words. Similarly, a constraint may be enforced that all phonemes in words that do not appear in the list of the most frequent 10,000 words must have a length of >=0.2 seconds. In another example, a constraint may be enforced that a pause after a stop word that does not end a sentence cannot be greater than 0.3 seconds.

At step 214, a timed text input is generated from the plurality of sung pause lengths and the plurality of sung phoneme lengths. In particular, each phoneme and pause in the text input is stored in association with its respective optimal timing (i.e., length) information determined in the previous steps. The timed text input (i.e., the text input and associated timing information) may be stored in an array, a record, and/or a file in a suitable format. In one example, a given phoneme in the timed text input may be stored as a record along with the lower and upper optimal length values, such as the following:

{“dh-ax-s”, 0.1, 0.5}

where the phoneme “dh-ax-s” (an ARPABET representation of the pronunciation of the word “this”) has been assigned an optimal sung phoneme length of between 0.1 and 0.5 seconds.

At step 216, a plurality of matching metrics is generated for each of a respective plurality of portions of the timed text input against a plurality of melody segments. The plurality of melody segments may be accessed in a MIDI file or other format. In addition to a melody line, a musical score or other information for providing an accompaniment to the melody may be accessed. For example, a stored backing track may be accessed and prepared to be played out in synchronization with the melody segments as described in later steps.

In particular, the timed text input may be broken up into portions representing sentences, paragraphs of text, or other units. Each portion is then compared to a plurality of melody segments, with each melody segment being a musical line having its own pitch and timing information.

Each melody segment may be thought of as the definition of a song, melody, or portion thereof, and may comprise a score as discussed above. For example, the melody segment may include, for each note in the melody, a number of syllables associated with the note, a duration of the note, a pitch of the note, and any other timing information for the note (including any rests before or after the note). While reference is made to a “pitch” of the note, it will be appreciated that the pitch may not be an absolute pitch (i.e., 440 Hz), but rather may be a relative pitch as defined by its position within the entire melody. For example, the melody segment may indicate that a particular note within the melody should be shifted to note with integer pitch 69 (equivalent to the letter note “A” in the fourth octave), but if it is deemed impossible to pronounce an A in fourth octave, the entire melody may be shifted downwards, so that each subsequent note is lowered by the same amount.

Other methods of musical corrective action may also be undertaken to enhance comprehension of the generated audio output. For example, the pitch (and all subsequent pitches) may be shifted to the appropriate note as an audio input message (i.e., the user's speaking voice), or some number of pitches above or below that original note, with the goal of sounding as natural as possible. In some example, the MTD may attempt to shift the pitches of the song by a particular number of semitones based on the nature of the disorder, the original pitch of the speaker's voice, or based on some determination that performance in that octave will be aesthetically pleasing.

For each comparison of a portion of a timed text input to a melody segment, a matching metric is generated representing the “fit” of the portion of the timed text input to the corresponding melody segment. For example, a melody segment with notes whose timing aligns relatively closely with the timing information of the corresponding portion of the timed text input may be assigned a higher matching metric than a melody segment that does not align as well timing-wise. A melody segment having the highest matching metric for a portion of the timed text input may be selected for mapping onto by the portion of the timed text input in subsequent steps.

The melody segments may be selected based on their harmonic and rhythmic profiles, such as their tonic or dominant scale qualities over the course of the melody. A subset of available melody segments may be chosen as candidates for a particular timed text input based on similar or complimentary musical qualities to ensure melodic coherence and appeal. In some examples, a user (e.g., an instructor) may be permitted to select a tonal quality (e.g., major or minor key) and/or tempo using a graphical or voice interface.

In some embodiments, a dynamic programming algorithm may be employed to determine which phonemes or words within the timed text input are to be matched with which melody segments or notes thereof. The algorithm may take into account linguistic features as well as their integration with musical features. For example, the algorithm may apply the timed text input to a melody segment such that a point of repose in the music (e.g., a perfect authentic cadence, commonly written as a “PAC”) is reached where there is a significant syntactic break. As another example, the algorithm may prevent breaking up stop words such as “the” with their following constituents; may favor harmonic tension following the syntax of the text. As another example, the algorithm may favor a longer duration for words assumed to be more rare and/or harder to hear in order to optimize comprehension and musicality.

A score function may be used by the dynamic programming algorithm in some embodiments for purposes of generating the matching metric between the portion of the timed text input and melody segment. The score function may weigh individual criteria, and the weights may be automatically set, dynamically adjustable, or adjustable by a user. In one example, one criterion may be the difference between the sung phoneme length(s) and the constraints imposed by the corresponding melody segment. In some embodiments, this length criterion may account for 50% of the score function. The length criterion may take into account the fit of the melody segment to the sung phoneme length as determined in act 212 (80%), as well as syntactic/stop word analysis (10%), and word rarity (10%).

Another criterion taken into account in the scoring metric may be the degree to which pauses occur between complete clauses (30%). This may be determined by using a phrase structure grammar parser to measure the minimum depth of a phrase structure parsing of the sentence at which two sequential elements in the same chunking at that level are divided by the melody. If the depth is greater than or equal to some constant determined by the phrase structure grammar parser used (e.g., 4 for the open-source benepar parser), such a placement of the pause may be penalized.

Another criterion taken into account in the scoring metric may be the existence of unresolved tension only where the clause is incomplete (20%). A melody segment may be penalized where it causes a sentence or independent clause to end on the dominant or leading tone, or on a note with a duration of <1 beat.

In some examples, where none of the melody segment fit the portion of the timed text or voice input to a suitable degree, the timed text or voice input may be split into two or more subportions and the process repeated in an effort to locate one or a series of melody segments that fits each subportion of timed text or voice input to an acceptable degree.

At step 218, a patterned musical message is generated from the timed text or voice input and the plurality of melody segments based at least in part on the plurality of matching metrics. For example, each phoneme of the timed text input may be pitch shifted according to the corresponding notes(s) in the melody segment. The phoneme is set to the melody using phonetic transcription codes, such as ARPABET. The patterned musical message, with or without accompaniment, may then be output as a sound file, such as a .WAV or .MP3 file suitable for output by a playback device. In some examples, the patterned musical message may be stored (for example, in the memory 130) for future playback. In various examples, the patterned musical message may be transmitted to another device and stored by the receiving device for immediate or future playback. The patterned musical message may be encoded with timestamps indicating a relative or absolute time at which each portion (e.g., note) of the melody is to be output.

At step 218, after or concurrent with output of the patterned musical message, visual or textual information may optionally be presented to reinforce or complement the patterned musical message. For example, the MTD may cause to be displayed, on a display screen or on-head display (such as a virtual reality or augmented reality display-enabled headset), the wording or imaging reflective of wording currently being output as part of the patterned musical message. In some embodiments, text corresponding to the currently played phoneme or the larger unit in which it is contained (e.g., word or sentence) may be highlighted or otherwise visually emphasized in order to enhance comprehension or recall. Identification of the currently played phoneme may be performed with reference to a timestamp associated a respective timestamp associated with each phoneme in the patterned musical message.

In some examples, characters in text being displayed may have their appearance modified in a way intended to optimize cognition and/or recall. An example screenshot 500 is shown in FIG. 5. In that example, the word “APPLE” is shown, but with the letter “A” (shown at 510a) being modified, having lowered and extended the horizontal feature of the letter. The remaining letters 510b are unchanged in appearance. Such and similar modified, and partial forms of any letters may be stored in association with one or more disorders, and displayed only when appropriate to treat such disorders. Other examples of modifications to characters include size, font face, movement, timing, or location relative to the other characters. In other examples, visual representations of the word (e.g., a picture of an apple when the word “apple” is sung in the patterned musical message) may be shown on the display. In some embodiments, virtual reality or augmented reality elements may be generated and displayed.

At step 220, the method ends.

According to some embodiments, the method 200 may be performed using an MTD (e.g., MTD 100 as seen in FIG. 1). The MTD may be a dedicated device, or may be the user's mobile device executing special-programmed software. In some examples, the user may be undergoing treatment with selected pharmacotherapeutics or behavioral treatments, or the user may be provided with or otherwise directed to use the MTD in combination with a drug or other therapeutic treatment intended to treat a disorder.

In some embodiments as described above, the input message may be textual input received from the user via a physical or virtual keyboard or may be accessed in a text file or other file, or over a network. In other embodiments, the input text may be provided or derived from spoken or textual input by the user. In one example, the input message may be speech captured by a microphone (e.g., microphone 110) and stored in a memory (memory 130). In some examples, the intermediate step of parsing the input message spoken by the user into components parts of speech may be performed as a precursor to or in conjunction with step 206 as discussed above. In other examples, parsing the spoken input into text may be modified or omitted, and the waveform of the input message itself may simply be pitch-shifted according to certain rules and/or constraints as discussed below. In either case, it will be appreciated that a user's spoken input message may be mapped to and output as a melody in real-time or near-real-time as discussed herein.

An example block diagram of a process 250 for processing a variety of input messages is shown in FIG. 2B. For example, text input 254 may be received from a user and filtered and standardized at processing block 258, converted to phonemes at processing block 260, and used to generate a patterned musical message at processing block 262 based on a provided melody 266, according to the techniques described herein. In another example, spoken input is received at a microphone 252 and provided to an audio interface 256. Speech captured by the microphone 252 may undergo any number of pre-processing steps, including high pass, low pass, notch, band pass or parametric filtering, compression, expansion, clipping, limiting, gating, equalization, spatialisation, de-essing, de-hissing, and de-crackling. In some embodiments, the audio input may be converted to text (e.g., for display on a device) using speech-to-text language processing techniques aimed at enhancing language comprehension.

The spoken input may then be converted to text using voice/speech recognition algorithms and processed in the same manner as the text 254 in processing blocks 258, 260, and 262.

In another embodiment, the spoken input may be directly parsed at processing block 264 without the intermediate step of converting to text. The audio input message may be parsed or processed in a number of ways at processing block 264. In some examples, waveform analysis allows the system to delineate individual syllables or other distinct sounds where they are separated by (even brief) silence as revealed in the waveform, which represents the audio input message as a function of amplitude over time. In these embodiments, syllables may be tagged by either storing them separately or by storing a time code at which they occur in the audio input message. Other techniques may be used to identify other parts of speech such as phonemes, words, consonants, or vowels, which may be detected through the use of language recognition software and dictionary lookups.

In some embodiments, the system may be configured to operate in a real-time mode; that is, audio input received at the microphone, or textual input received by the system, is processed and converted to a portion of the patterned musical message nearly instantaneously, or with a lag so minimal that it is either not noticeable at all or is slight enough so as not to be distracting. Input may be buffered, and the steps 202-220 may be performed repeatedly on any buffered input, to achieve real-time or near-real time processing. In these embodiments, the most recent syllable of the audio input message may continuously be detected and immediately converted to a portion of the patterned musical message. In other embodiments, the system may buffer two or more syllables to be processed. In some embodiments, the time between receiving the audio or text input message and outputting the patterned musical message should be vanishingly small so as to be virtually unnoticeable to the user. In some examples, the delay may be less than 2 seconds, and in further examples, the delay may be less than 0.5 seconds. In some examples, the delay may be less than 5 seconds, or less than 10 seconds. While the translation of spoken voice or text into song using the MTD may lengthen its presentation and thus lead to the termination of the song more than 10 seconds after the speaker finishes speaking in the case of a long utterance, the flow of song will be smooth and uninterrupted and will begin shortly after the speaker begins speaking.

An exemplary user interface 300 for selecting a particular genre is shown in FIG. 3. The user interface 300 includes a list of selectable genres 310a-c, which may be selected by touching or otherwise interacting with the user interface. Additional information about the genre may be displayed by clicking on the corresponding information indicator 312a-c next to each genre. Controls 316a,b allow the user to scroll up and down or otherwise navigate the list, and a search functionality may be provided by interacting with control element 320. The search functionality may allow the user to search for available genres.

It will be appreciated that a broad selection of melodies and melody segments will facilitate optimal matching of the time text input to melody segments (e.g., in steps 216 and 218 discussed above), and that such a broader selection also increases user engagement and enjoyment. It will also be appreciated that identifying melodies for inclusion in the pool of available options may be time-intensive, since a desired melody may be provided in available music alongside rhythm and other tracks. For example, a MIDI music file for a particular song may contain a melody track along with other instrumentation (e.g., a simulated drum beat or bass line), and one or more harmony lines. There is therefore an advantage to providing an automatic method of identifying a melody among a collection of tracks forming a musical piece, in order to add additional melody segments to the collection available for matching to the timed text input as discussed above. This is accomplished by detecting one or more characteristics of a melody within a given musical line and scoring the musical line according to its likelihood of being a melody.

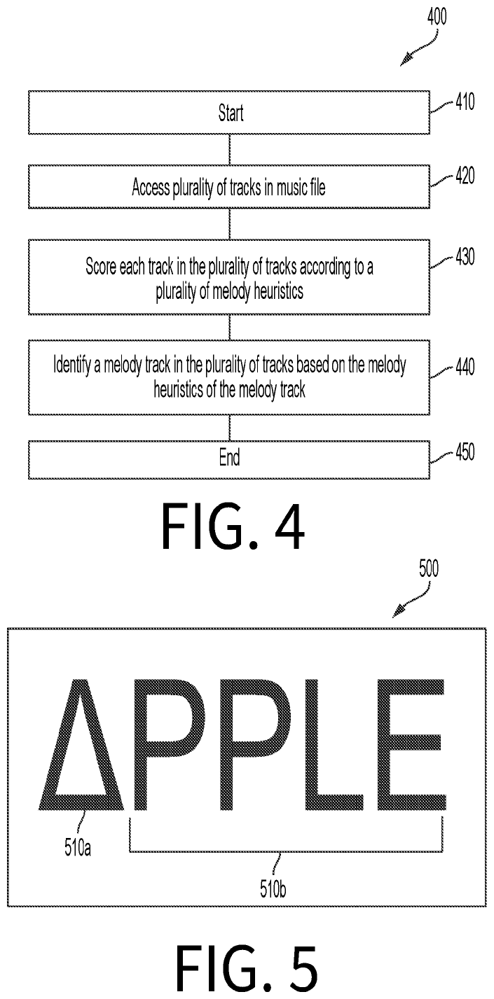

A method 400 of determining a melody track in a music file is described with reference to FIG. 4.

At step 410, the method begins.

At step 420, a plurality of tracks in a music file are accessed. For example, a MIDI file, a musicXML file, abc format file or other file format, may be accessed and all of the individual lines as defined by the channels/tracks in the MIDI file will be stored and accessed. Each of these lines can be evaluated as a possible melody line.

At step 430, each of the plurality of tracks is scored according to a plurality of melody heuristics. The plurality of melody heuristics may represent typical identifying characteristics of a melody. For example, the melody heuristics may represent the amount of “motion” in the melody, the number of notes, the rhythmic density (both in a given section and throughout the piece), the entropy (both in a given section and throughout the piece), and the pitch/height ambitus of the track. The melody heuristics may score a track according to a number of specific criteria that quantify those characteristics. For example, a track may be scored according to the number of interval leaps greater than a certain amount (e.g., 7 semitones); a track with a greater number of such large jumps may be less likely to be the melody. In another example, the track may be scored according to its total number of notes; a track having more notes may be more likely to be the melody. In another example, the track may be scored according to a median number of notes with no significant rest in between them; a track with fewer rests between notes may be more likely to be the melody. In another example, the track may be scored according to a median Shannon entropy of every window of the melody between 8 and 16 notes long; a track with a higher entropy may be more likely to be the melody. In another example, the track may be scored according to a number of notes outside of a typical human singing range (e.g., notes outside of the range of MIDI pitches from 48 to 84); a track with more unsingable notes may be less likely to be the melody. Other measurements that could be used include mean, median, and standard deviation of length of note durations, note pitches, and absolute values of intervals between notes, or other mathematical operators on the contents of the MIDI file.

A subscore may be determined for each of these and other criteria, and aggregated (e.g., summed) to a melody heuristic score for the track.

At step 440, a melody track is identified from among the plurality of tracks based at least in part on the plurality of melody heuristics for the melody track. For example, after each candidate track has been scored, the track with the highest melody heuristic score may be identified as the melody track. In some examples, where more than one track has a sufficiently high melody heuristic score, the candidate melody tracks may be presented to a user graphically, or may be performed audibly, so that the user can select the desired/appropriate melody track.

At step 450, the method ends.

After the melody track is identified, it may be split into melody segments, stored, and used to match with portions of timed text inputs as discussed above with reference to FIGS. 2A-2C.

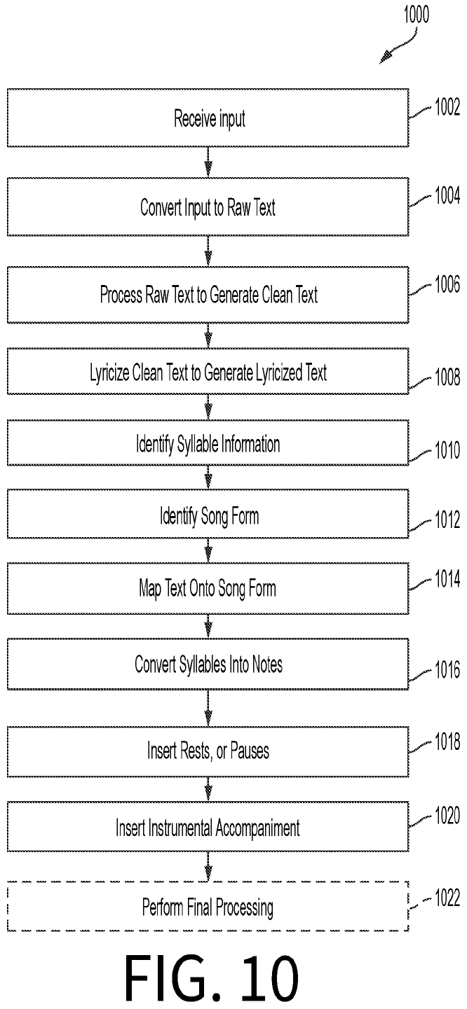

FIG. 10 illustrates a process 1000 of transposing an input to a patterned musical message according to another example. The process 1000 may be executed by a musical translation device, such as the MTD 100. In at least one example, the process 1000 may be executed at least in part by the MTD 100 and in at least in part by at least one external device communicatively coupled to the MTD 100. In some examples, the MTD 100 may be configured to execute any of the processes 200, 250, 400, and/or 1000 individually and/or in combination. For example, acts of one or more of the processes 200, 250, 400, and/or 1000 may be added to and/or used to substitute one or more acts of others of the processes 200, 250, 400, and/or 1000. For purposes of example, acts of the process 1000 are described with reference to the MTD 100.

At act 1002, the MTD 100 receives an input. The input may include, or be used to determine, text. For example, the input may be a text file, a file containing text (for example, a PDF file, a Word file, and so forth), an image containing text, and/or another representation or text.

At act 1004, the MTD 100 converts the input to raw text. For example, the text may be extracted from a file, such as a text file, a PDF file, a Word file, and so forth. In another example, the MTD 100 may execute one or more image-processing algorithms to extract text from one or more images containing text.

At act 1006, the MTD 100 processes the raw text to generate clean text. For example, the MTD 100 may remove one or more invalid characters from the raw text. Invalid characters may include characters other than letters (which may be limited to letters of one or more specific alphabets), numbers, and/or punctuation marks. The MTD 100 may also add one or more elements to the raw text to generate the clean text such as by adding one or more letters to misspelled words, adding punctuation marks to re-format the text, removing extraneous spaces, replacing a known abbreviation with the words that the abbreviation stands for, removing special characters or punctuation marks (for example, ellipses), and so forth. The MTD 100 may also remove one or more invalid words, which may include misspelled words, misspelled words for which an intended (for example, properly spelled) word is unclear, words not in an intended language, and so forth.

At act 1008, the MTD 100 lyricizes the clean text to generate lyricized text. Lyricization may include modifying the clean text into a format that song lyrics may adhere to. For example, the clean text may be divided into one or more lines in the same manner that song lyrics are often divided. The MTD 100 may divide the text input into lines based on at least one type of punctuation mark. For example, the MTD 100 may divide the text input into new lines at each comma and/or period in the text input, such that text appearing between two punctuation marks makes up a line. Lyricized text therefore represents text broken into lines resembling lines of lyrics.

At act 1010, the MTD 100 identifies syllable information for each word in the lyricized text. Syllable information may include syllable length, stress, part of speech, phonemic representation in ARPAbet, and so forth. The MTD 100 may execute one or more syllable-information-identification algorithms to identify the syllable information. For example, the MTD 100 may execute one or more natural-language-processing algorithms implementing a text-to-speech voice-synthesis library, such as the F-LITE library. Executing an algorithm implementing the F-LITE library may therefore identify syllable information for each word of the lyricized text and associate the syllable information as metadata for the words, such that a number of syllables for each word, and other metadata about the syllables, is tagged to each word and syllable.

At act 1012, the MTD 100 selects, or receives information indicative of a selection of, a song form. A song form may include a template of patterned sections of text or lyrics (including, for example, a sung duration of one or more sections of text) defined by one or more patterned chord progressions. Chords include a set of notes defined relative to a musical scale. In various examples, a user may provide an input indicating a desired song form and, in some examples, a musical genre. The MTD 100 may select or otherwise identify a song form based on the user input in some examples. The user input may be received prior to executing the process 1000 in some examples, and/or the MTD 100 may select or otherwise identify a song form based on the user input prior to executing the process 1000 in some examples. The MTD 100 may implement one or more machine-learning and/or artificial-intelligence processes or algorithms to select a song form based at least in part on a user selection. For example, if a user has a preference for a certain genre or singer (for example, because the user enjoys the genre or singer, or because the genre or singer is effective in providing a desired treatment), the MTD 100 may learn the user's preferences over time to select an optimal song form in future operations.

At act 1014, the MTD 100 maps the lyricized text onto the song form. The template encompassed by the song form may specify a number of notes per line. Act 1014 may include mapping the syllables of the lyricized text onto notes specified by the song form. The song form may specify a number of notes per line. In some examples, the song form indicates a maximum number of notes (or syllables) per line. Accordingly, if a first line of lyricized text includes ten syllables, but a first line of the song-form template includes nine notes, the last word in the first line of the lyricized text may be moved down to a subsequent line (or a new line may be inserted) to reduce the number of syllables to be equal to or less than the number of notes in the first line of the song-form template. Each line of the lyricized text may be analyzed and mapped onto the song-form template in turn. In other examples, a maximum number of syllables per line may be enforced at different points in the process 1000. For example, the maximum number of syllables per line may be enforced during lyricization and prior to mapping the lyrics onto a song form. In another example, the maximum number of syllables per line may be enforced as a final-processing step after the lyrics have been mapped onto the song form.

At act 1016, the MTD 100 converts the syllables into musical notes. Generating musical notes may include assigning a duration and pitch to each syllable, thereby converting the syllable into a note. The syllable information identified at act 1010 may remain associated with each syllable after the syllable is converted to a note. Examples of assigning a duration and a pitch to each syllable are discussed below.

At act 1018, the MTD 100 inserts rests (or pauses) into the text input. For example, the MTD 100 may insert a rest at the end of each line of notes. In some examples, once the syllables are converted into musical notes and rests are added, a patterned musical message has been generated. The patterned musical message may represent a vocal melody.

At act 1020, the MTD 100 adds instrumental accompaniment to the patterned musical message to generate song data. In one example, instrumental accompaniment (for example, bass lines, drum lines, and so forth) may be generated from a pre-defined song form matching a genre (for example, selected by a user) and/or other musical characteristics aligned with the patterned musical message. Accordingly, the song data includes not only a patterned musical message (that is, a vocal melody) but also an instrumental accompaniment aligned with the patterned musical message. The patterned musical message may, as discussed above, be used to generate a sung output for playback to a user. In some examples, the MTD 100 may generate an audio file encoding the patterned musical message.

At optional act 1022, the MTD 100 may perform optional final processing. For example, the MTD 100 may redistribute one or more notes from some lines to others. The redistribution may be performed to conform to a user-defined maximum specified syllable count, for example. As discussed above, the redistribution may be executed at one of several points in the process 1000, such as after lyricizing the text, after mapping the lyricized text onto the song form, after assigning a rhythm to the text, and so forth.

Accordingly, the MTD 100 may execute the process 1000 to generate a patterned musical message. As discussed above, the MTD 100 may additionally or alternatively execute either or both of the processes 200, 250 to generate a patterned musical message.

As discussed above, the MTD 100 may assign at least one rhythm to the lyricized text to generate a musical note. Assigning the at least one rhythm may include assigning a duration and a pitch to each syllable derived from the lyricized text mapped onto the song form. In some examples, the at least one rhythm may be determined based at least in part on a rhythmic pattern selected by the MTD 100 and/or a user. The rhythmic pattern may specify a duration and pitch for each note in a line. The MTD 100 may assign the at least one rhythm on a line-by-line basis of the text which has been mapped onto a song form. Pitch data and duration data may be generated for each template line based at least in part on the chord progression for the respective section specified by the rhythmic pattern. A pitch and a duration may be assigned to each note in the lyricized text.

If a number of notes in the rhythmic pattern differs from a number of syllables in the text which has been mapped onto the song form, one or more notes may be added or removed from the rhythmic pattern and/or the text such that the numbers of notes are equal. The MTD 100 may execute an interpolation algorithm to add or remove syllables. For example, if a rhythmic pattern has ten notes, and a line of text or lyrics has eight syllables, notes may be removed from the rhythmic pattern or syllables may be added to the text. In one example, the MTD 100 may divide the ten notes of the rhythmic pattern equally into two groups of five notes, and remove a note from each group such that a total number of notes is eight. In another example, the MTD 100 may divide the eight syllables of the lyrics into two groups of four and add a syllable to each group such that the total number of syllables is ten. In other examples, other implementations may be provided.

An example of the process 1000 is provided for illustrative purposes. A user indicates a selection of a text input, such as a Word document attached to an e-mail (act 1002). For example, the user may be using the MTD 100 to access an e-mail application, and may select the e-mail attachment displayed by the e-mail application. For the purposes of this example, the text input may be in the e-mail attachment may recite, “Htis is a first sentence. This is a second sentence #. This is the third, and final, sentence.”

The MTD 100 converts the text input to a raw text input (act 1004). For example, the MTD 100 may extract the text from the Word document. The MTD 100 then cleans up the raw text (act 1006). For example, the MTD 100 may identify that “Htis” is not a properly spelled word, and may determine that the intended word is “This.” The MTD 100 may execute one or more known spell-checking algorithms to identify and correct misspellings in some examples. The MTD 100 may also identify that the “#” character is not a valid character and should be removed. In some examples, the MTD 100 may remove all characters that are not letters or numbers. In other examples, the MTD 100 may allow certain characters. For example, the MTD 100 may allow all or some characters, such as the “#” symbol, or may allow certain characters depending on a context. For example, if the “#” precedes a number, or if the MTD 100 determines, based on context, that the “#” is being used as a “hash tag” in a social-media context, the MTD 100 may not remove the “#” character. In this example, the MTD 100 may determine that the “#” character should be removed. Accordingly, the MTD 100 converts the raw text input to cleaned text, which recites, “This is a first sentence. This is a second sentence. This is the third, and final, sentence.”

The MTD 100 then lyricizes the cleaned text (act 1008). The MTD 100 may divide the cleaned text into sections broken by commas and periods. Accordingly, a first section of the cleaned text may be “This is a first sentence.” A second section of the cleaned text may be “This is a second sentence.” A third section of the cleaned text may be “This is a third.” A fourth section of the cleaned text may be “and final.” A fifth section of the cleaned text may be “sentence.” Each section may alternately be referred to as a “line,” indicating that the sections may be used to generate a song composed of lines of lyrics.

The MTD 100 identifies syllable information for each section of the cleaned text (act 1010). The MTD 100 may execute an F-LITE algorithm to identify the syllables in each word. For example, for the fifth section of the cleaned text, the MTD 100 may determine that “sentence” contains two syllables, that the first syllable is a stressed syllable, and that a part-of-speech of the word “sentence” is “noun.” That MTD 100 may determine an ARPAbet representation of the fifth section and may determine a length (for example, a duration to pronounce) of each syllable. Additional syllable information and metadata may be identified in some examples.

The MTD 100 then selects a song form for the lyricized text (act 1012). For example, the MTD 100 may select a song form based on a user input. In one example, the user input includes a requested genre and/or singer. For example, the user input may be a selection of the “country” genre. The MTD 100 may then select a song form based on the “country”-genre selection. For example, the MTD 100 may randomly select a song form from a group of one or more song forms corresponding to the “country” genre. The selected song form may include a template of patterned lines having a certain number of syllables, such as by having four lines with six, seven, four, and five syllables, respectively.

The MTD 100 then maps the lyricized text onto the template of the selected song form by correlating each syllable of text to a respective syllable in the song form (act 1014). For example, if the first line of lyricized text includes ten syllables, but the first line of the song-form template includes eight syllables, the first eight syllables of the lyricized text may be mapped onto the first line of the song-form template.

The MTD 100 converts each identified syllable into a musical note (act 1016). For example, in the fifth section, the first syllable and the second syllable may be converted into musical notes. Converting the syllables into notes may include assigning a pitch and a duration to each note pursuant to a rhythmic pattern.

The MTD 100 then inserts rests at the end of each line (act 1018). For example, a rest is inserted after the line “This is a first sentence.” After inserting rests, if the text were written in a format that lyrics are often written in (that is, where a line break indicates a rest, or pause, between lyrics), the text may be written as follows:
This is a first sentence.
This is a second sentence.
This is a third,
and final,
sentence.

The MTD 100 then adds at least one musical accompaniment to the text, or the patterned musical message (that is, a vocal melody) that has been generated (act 1020). For example, the MTD 100 may add at least one drum line, at least one bass line, and so forth, to the patterned musical message to generate song data. The MTD 100 may add the musical accompaniment using the notes as inputs to a musical-accompaniment-generation algorithm.

The MTD 100 may optionally redistribute musical notes (act 1022). For example, the MTD 100 may determine that the final and penultimate lines of the text contain too few syllables. The MTD 100 may thus move the final line into the penultimate line, such that the redistributed text recites,
This is a first sentence.
This is a second sentence.
This is a third,
and final, sentence.

In other examples, the MTD 100 may not redistribute any musical notes. For example, the MTD 100 may determine that the text already exhibits sufficient lyricality and that no modification is necessary.

In some examples, the MTD 100 may output an acoustic signal representing the song data. As discussed below, the MTD 100 may generate and output the acoustic signal in real-time, near-real-time, or non-near-real-time. In another example, the MTD 100 may communicate the patterned musical message to one or more other devices to output an acoustic signal representing the patterned musical message.

A musical translation device, such as the MTD 100, may be capable of operating in real-time or near-real-time such that a patterned musical message is played back (for example, via the speaker/output 140) in substantially real- or near-real-time as the patterned musical message is generated. In various examples, the MTD 100 is capable of operating in real-time, near-real-time, and/or non-real-time. For example, the MTD 100 may generate a patterned musical message as discussed above with respect to act 218, but rather than (or in addition to) outputting the generated patterned musical message in real-time, may store the patterned musical message for later playback in the memory 130. Alternately or in addition, the MTD 100 may transmit a signal encoding the patterned musical message to another device via the interface 190, and the receiving device may store and/or output the received message upon receipt or at a subsequent time thereafter. Accordingly, it is to be appreciated that, although the MTD 100 is capable of operating in real-time or near-real-time, the MTD 100 may be further capable of operating in non-real-time. Furthermore, in some examples, the MTD 100 may be capable of operating only in real-time, only in non-real-time, only in near-real-time, only in real-time and near-real time, or only in near-real-time and non-real-time. A structure of a musical translation device capable of operating in a first set of one or more modes of operation (for example, real-time and near-real-time) may be identical to a structure of a musical translation device capable of operating in a second set of one or more modes of operation (for example, non-real-time).

In other examples, a structure of an MTD that is capable of operating in real-time may differ from a structure of an MTD that is not capable of operating in real-time. For example, a device configured to store one or more patterned musical messages may have additional storage as compared to a device not configured to store one or more patterned musical messages. In another example, an MTD configured to output an audible patterned musical message may include one or more audio transducers, whereas an MTD not configured to output an audible signal may not include any audio transducers. In another example, an MTD configured to output a signal encoding a patterned musical message or other message information to a second, remote device may include a communication interface, whereas an MTD not configured to output such a signal may not include such an interface. As discussed above, an MTD may be a dedicated device, or may be (or be implemented in connection with) a non-dedicated device, hardware, or software, such as a desktop computer, a laptop computer, a smartphone, an electronic tablet, software applications, and so forth.

Executing text-to-song operations in real-time or near-real-time (including examples in which text is derived from voice, such that the operation may be considered a voice-to-song operation), such as by the MTD 100, may be implemented in any of various technologies. For example, a user may use the MTD 100 to execute a text-to-song operation with respect to text from an e-mail, a social-media application (for example, Twitter, Facebook, Instagram, and so forth), a web browser, and so forth. The text-to-song operation may be particularly advantageous for users with reading, listening, and/or comprehension impairments, such as dyslexia, ADHD, or other learning impairments.

In various examples, such a text-to-song operation may advantageously provide substantially immediate playback of a message (for example, as a sung message) upon opening the message (for example, upon opening an email, upon clicking on a Tweet, and so forth). As discussed below, user preferences may be considered in generating a sung output, such as a desired singer and/or genre.

### Multiple-Device System

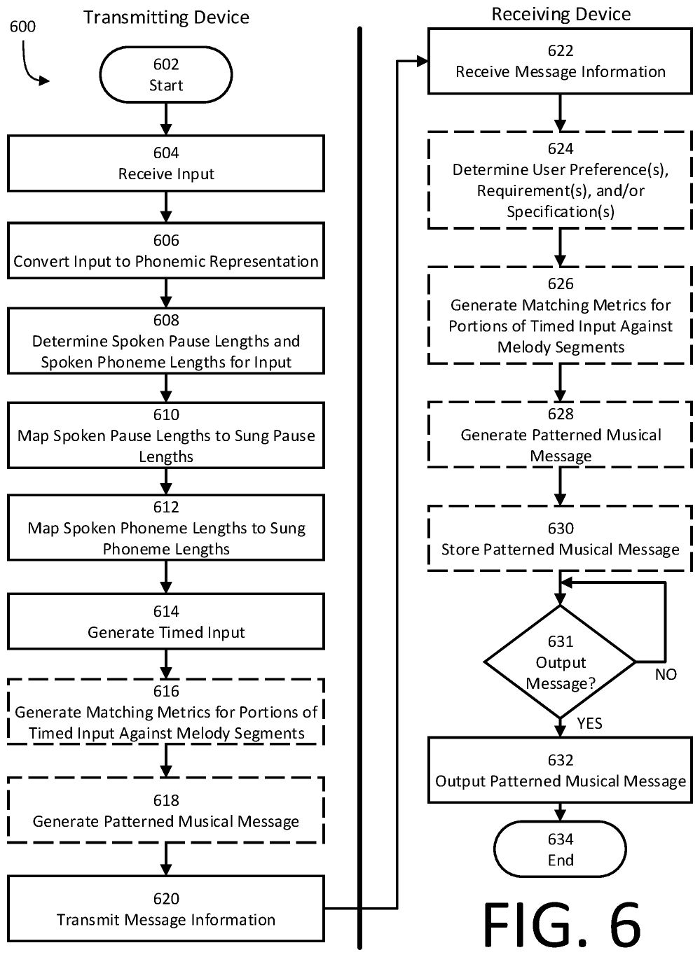

As discussed above, one or more devices may communicate with one another to generate, store, and/or play back a patterned musical message. The one or more devices may include, for example, one or more MTDs, which may be or include one or more laptop computers, desktop computers, tablet computers, smartphones, dedicated devices, and so forth. As discussed below with respect to FIG. 6, a first device may perform one or more operations towards generating a patterned musical message and sending message information to a second device, and the second device may perform one or more operations to output an acoustic signal to a user based on the message information. Either or both of the devices may store the patterned musical message and/or message information used to generate or determine the patterned musical message. In some examples, message information may not include the patterned musical message itself, but may include information that can be used by the second device to generate a patterned musical message. In other examples, the message information may include a patterned musical message, that may be used as such (that is, output in an acoustic signal) or that can be used by the second device or second user to generate yet a distinct user-specific patterned musical message based on, for example, preferences of the second user.

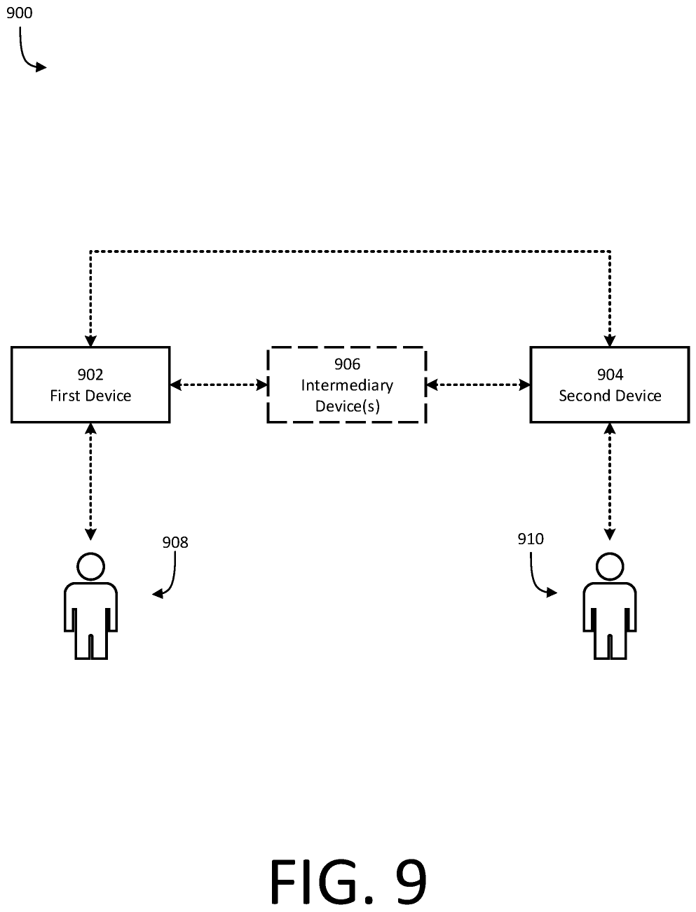

Various examples including multiple devices are provided for purposes of explanation. FIG. 9 illustrates a multiple-device system 900 according to an example. The multiple-device system 900 includes a first device 902, a second device 904, one or more optional intermediary devices 906, a first user 908, and a second user 910. Each of the devices 902, 904 may be, for example, a laptop computer, a smartphone, a desktop computer, a tablet computer, a musical translation device, which may be embodied as the MTD 100 or another, structurally similar or identical device including non-real-time musical translation devices, and so forth. One or more of the one or more optional intermediary devices 906 may include, for example, one or more servers, databases, computers, routers, consumer electronic devices, or other computing devices.

The first device 902 may be communicatively coupled to the second device 904 directly and/or via the one or more optional intermediary devices 906. In some examples, the devices 902, 904 may be communicatively coupled via one or more network connections including, for example, a wired or wireless Internet connection. As discussed in greater detail below, the devices 902, 904 may exchange message information, which may be, include, or be used to generate a patterned musical message.

For example, the first user 902 may prepare a message including text to be sent to the second user 904, such as an advertisement, electronic message (for example, an e-mail), and so forth, using the first device 902. The first device 902 may send message information including the message to the second device 904 directly or via the one or more intermediary devices 906, and the second device 904 may output a patterned musical message to the second user 910 based on the message information. Accordingly, the system 900 enables the first user 908 to send a message to the second user 910, which message may be output as a patterned musical message.

In one example, a first device may be operated by an advertiser seeking to provide an advertisement to a user. The first device may send message information indicative of the advertisement to a second device operated by the user. The second device may generate an acoustic signal based on the message information, such that the user is presented with contents of the advertisement via the acoustic signal.

In another example, a first device may be operated by a first user seeking to send an e-mail, or other electronic message, to a second user. The first device may send message information indictive of the electronic message to a second device operated by the second user. The second device may generate an acoustic signal based on the message information, such that the user is presented with contents of the electronic message via the acoustic signal.

In other examples, other implementations are contemplated. In any of the foregoing examples, user preferences, requirements, or specifications (for example, corresponding to either or both of the first and second devices) may be considered in generating the patterned musical message and/or outputting the acoustic signal.

FIG. 6 illustrates a swim-lane diagram of a process 600 for outputting a patterned musical message. A left-hand column of the swim-lane diagram indicates operations of a transmitting device which, as discussed below, is configured to provide message information to a receiving device for playback to a user. In some examples, the transmitting device may be, for example, the first device 902. A right-hand column of the swim-lane diagram indicates operations of the receiving device which, as discussed below, is configured to receive the message information from the transmitting device and output an acoustic signal based on the message information to the user. In some examples, the receiving device may be, for example, the second device 904.

At act 602, the process 600 begins.

At act 604, the transmitting device receives an input. Act 604 may be similar to act 204, discussed above, except that act 604 contemplates the receipt of user inputs including text inputs, voice inputs, graphical inputs, and so forth. In some examples, act 604 may include accessing a previously stored input. For example, a previously stored input may be stored in local and/or remote storage. Accordingly, it is to be appreciated that act 604 need not include receiving an input from a user in real-time and could instead include accessing a previously stored input, although such an example is within the scope of the disclosure.

A text input may be received, for example, by accessing a text file based on an electronic message prepared by a first user. For example, the text input may be received by the first device 902 from the first user 908, where the text input includes an e-mail that the first user 908 desires to send to the second user 910 via the second device 904. In another example, a text input may be accessed from a graphical input in which the text is included (for example, an image or photo), such as an advertisement containing text in combination with graphical content. The text may be formatted or unformatted. The text may be received via a wired or wireless connection over a network, or may be provided on a memory disk. In other embodiments, the text may be typed or copy-and-pasted directly into a device by a user. In still other embodiments, the text may be obtained by capturing an image of text and performing OCR on the image. The text may be arranged into sentences, paragraphs, and/or larger subunits of a larger work. An input may be received in real-time, near-real-time, or non-real time, such as by accessing an input from storage. An input may be received from a user, and/or may be obtained automatically without an affirmative input from a user. For example, act 604 may be executed responsive to the transmitting device determining that a user is drafting an e-mail, whether or not the user provides an express input to the transmitting device indicating that the process 600 should be executed.

An audio input may be received by a microphone and may undergo any number of pre-processing steps, including high-pass, low-pass, notch, band-pass or parametric filtering, compression, expansion, clipping, limiting, gating, equalization, spatialisation, de-essing, de-hissing, and de-crackling. In one example, an audio input may be received by, for example, a user verbally dictating an electronic message, such as an e-mail, into the transmitting device. In another example, an audio input may be stored in an audio file and accessed by the transmitting device in real-time as the audio input is received and stored, or in non-real-time whereby a stored audio file is accessed a non-negligible time after the audio file is stored or received. For example, the audio input may be an audio file in, or audio component of, an advertisement that includes spoken words. In some embodiments, the audio input may be converted to text (for example, for display on a device) using speech-to-text language processing techniques aimed at enhancing language comprehension. The spoken input may then be converted to text using voice/speech recognition algorithms and processed in the same manner as the text input discussed above.

At act 606, the user input is converted to a phonemic representation. Act 606 may be substantially similar to act 206. The user input is converted into a phonemic representation, as can be represented by any standard format such as ARPABET, IPA or SAMPA. This may be accomplished, in whole or in part, using free or open-source software, such as, or including, Phonemizer, and/or the Festival Speech Synthesis System developed and maintained by the Centre for Speech Technology Research at the University of Edinburgh. However, in addition, certain phonemes in certain conditions (for example, surrounded by other phonemes) are to be modified so as to be better comprehended as song. The phonemic content may be deduced by a lookup-table mapping (spoken phoneme, spoken phoneme surroundings) to (sung phoneme). In some cases, the entire preceding or consequent phoneme is considered when determining a given phoneme, while in other cases only the onset or end of the phoneme is considered. In some examples, a series of filters may be applied to the user input to standardize or optimize the user input. For example, filters may be applied to convert abbreviations, currency signs, and other standard shorthand to a form more suited for conversion to speech.

At act 608, a plurality of spoken pause lengths and a plurality of spoken phoneme lengths are determined for the user input. Act 608 may be substantially similar to act 208. The length of the pauses and the phonemes represented in the user input may be determined with the help of open-source software or other sources of information regarding the prosodic, syntactic, and semantic features of the text or voice. The process may involve a lookup table that synthesizes duration information about phonemes and pauses between syllables, words, sentences, and other units from other sources which describe normal speech. In some examples, the spoken length of phonemes may be determined and/or categorized according to their position in a larger syntactic unit (for example, a word or sentence), their part of speech, or their meaning. In some examples, a dictionary-like reference may provide a phoneme length for specific phonemes and degrees of accent. For example, some phonemes may be categorized as having a phoneme length of less than 0.1 seconds, less than 0.2 seconds, less than 0.3 seconds, less than 0.4 seconds, or less than 1.0 seconds. Similarly, some pauses may be categorized according to their length during natural spoken speech, based upon their position within the user input or a subunit thereof, the nature of phonemes and/or punctuation nearby in the user input, or other factors.

At act 610, the plurality of spoken pause lengths is mapped to a respective plurality of sung pause lengths. Act 610 may be substantially similar to act 210. For example, a Level 1 spoken pause (as discussed above) in spoken form may be mapped to a Level 1 sung pause, which may have a longer or shorter duration than the corresponding spoken pause. In some examples, any Level 1 spoken pause may be mapped to an acceptable range of Level 1 sung pauses. For example, a Level 1 spoken pause may be mapped to a range of Level 1 sung pauses of between 0.015 to 0.08 seconds or between 0.03 to 0.06 seconds. Similarly, a Level 2 spoken pause may be mapped to a sung pause of between 0.02 to 0.12 seconds or between 0.035 to 0.1 seconds. A Level 3 spoken pause may be mapped to a sung pause of between 0.05 to 0.5 seconds or between 0.1 to 0.3 seconds; and a Level 4 spoken pause may be mapped to a sung pause of between 0.3 to 1.5 seconds or between 0.5 to 1.0 seconds.

At act 612, the plurality of spoken phoneme lengths is mapped to a respective plurality of sung phoneme lengths. Act 612 may be substantially similar to act 212. The mapping may represent, for a spoken phoneme of a given length, a range of optimal lengths for the phoneme when sung. In some examples, a lookup table may be used, such as the following:

| | |
|---|---|
| Spoken Phoneme Length | Optimal Sung Phoneme Length |

| | | |
|---|---|---|
| <0.1 | seconds | 0.1 to 0.5 seconds |
| <0.2 | seconds | 0.3 to 0.7 seconds |
| <0.3 | seconds | 0.35 to 0.8 seconds |
| >=0.3 | seconds | 0.4 to 0.9 seconds |

In another example, a broader range of values may be used:

| | |
|---|---|
| Spoken Phoneme Length | Optimal Sung Phoneme Length |

| | | |
|---|---|---|
| <0.1 | seconds | 0.05 to 0.7 seconds |
| <0.2 | seconds | 0.2 to 0.9 seconds |
| <0.3 | seconds | 0.3 to 1.0 seconds |
| >=0.3 | seconds | 0.35 to 1.5 seconds |

It will be appreciated that the plurality of spoken pause lengths and the plurality of spoken phoneme lengths applied in steps 610 and 612, respectively, may be determined with reference to one or more parameters. Those parameters may include optimal breaks between sentences, optimal tempo, optimal time signature, optimal pitch range, and optimal length of phonemes, where optimality is measured with respect to facilitating comprehension and/or recollection. In some cases, a number of these factors may be applied, possibly with relative weights, in mapping the plurality of spoken pause lengths and the plurality of spoken phoneme lengths.

Certain constraints may be imposed on the plurality of spoken pause lengths and the plurality of spoken phoneme lengths. In particular, spoken pause lengths and spoken phoneme lengths determined in the previous steps may be adjusted according to certain constraints in order to optimize comprehension and musicality. The constraints may be set based on the frequency/commonality of the word, or on its position within a sentence or clause, such as a “stop” word. For example, a constraint may be enforced that all phonemes in stop words must have a length of <=0.6 seconds. A stop word, as used herein, may be natural language words which have very little meaning, such as “and,” “the,” “a,” “an,” and similar words. Similarly, a constraint may be enforced that all phonemes in words that do not appear in the list of the most frequent 10,000 words must have a length of >=0.2 seconds. In another example, a constraint may be enforced that a pause after a stop word that does not end a sentence cannot be greater than 0.3 seconds.

At act 614, a timed text input is generated from the plurality of sung pause lengths and the plurality of sung phoneme lengths. In some examples, the plurality of sung pause lengths and the plurality of sung phoneme lengths may be collectively referred to as a “sung input,” and mapping the plurality of spoken pause lengths to the respective plurality of sung pause lengths and mapping the plurality of spoken phoneme lengths to the respective plurality of sung phoneme lengths may be referred to as mapping an input (such as a spoken input, user input, text input, voice input, graphical input, and so forth) to the sung input. In these examples, act 614 may include generating a timed text input from the sung input. Act 614 may be substantially similar to act 214. Each phoneme and pause in the user input is stored in association with its respective optimal timing (that is, length) information determined in the previous steps in an array, a record, and/or a file in a suitable format. In one example, a given phoneme in the timed text input may be stored as a record along with lower and upper optimal length values as discussed above.

At optional act 616, a plurality of matching metrics may be generated for each of a respective plurality of portions of the timed text input against a plurality of melody segments. The plurality of melody segments may be accessed in a MIDI file or other format. In addition to a melody line, a musical score or other information for providing an accompaniment to the melody may be accessed. For example, a stored backing track may be accessed and prepared to be played out in synchronization with the melody segments as described in later steps.

In particular, the timed text input may be broken up into portions representing sentences, paragraphs of text, or other units. Each portion is then compared to a plurality of melody segments, with each melody segment being a musical line having its own pitch and timing information.

Each melody segment may be thought of as the definition of a song, melody, or portion thereof, and may comprise a score as discussed above. For example, the melody segment may include, for each note in the melody, a number of syllables associated with the note, a duration of the note, a pitch of the note, and any other timing information for the note (including any rests before or after the note). While reference is made to a “pitch” of the note, it will be appreciated that the pitch may not be an absolute pitch (i.e., 440 Hz), but rather may be a relative pitch as defined by its position within the entire melody. For example, the melody segment may indicate that a particular note within the melody should be shifted to note with integer pitch 69 (equivalent to the letter note “A” in the fourth octave), but if it is deemed impossible to pronounce an A in fourth octave, the entire melody may be shifted downwards, so that each subsequent note is lowered by the same amount.

Other methods of musical corrective action may also be undertaken to enhance comprehension of the generated audio output. For example, the pitch (and all subsequent pitches) may be shifted to the appropriate note as an audio input message (that is, the user's speaking voice), or some number of pitches above or below that original note, with the goal of sounding as natural as possible. In some example, the device may attempt to shift the pitches of the song by a particular number of semitones based on the nature of the disorder, the original pitch of the speaker's voice, or based on some determination that performance in that octave will be aesthetically pleasing.

For each comparison of a portion of a timed text input to a melody segment, a matching metric is generated representing the “fit” of the portion of the timed text input to the corresponding melody segment. For example, a melody segment with notes whose timing aligns relatively closely with the timing information of the corresponding portion of the timed text input may be assigned a higher matching metric than a melody segment that does not align as well timing-wise. A melody segment having the highest matching metric for a portion of the timed text input may be selected for mapping onto by the portion of the timed text input in subsequent steps.

The melody segments may be selected based on their harmonic and rhythmic profiles, such as their tonic or dominant scale qualities over the course of the melody. A subset of available melody segments may be chosen as candidates for a particular timed text input based on similar or complimentary musical qualities to ensure melodic coherence and appeal. In some examples, a user (for example, an instructor) may be permitted to select a tonal quality (for example, major or minor key) and/or tempo using a graphical or voice interface.

In some embodiments, a dynamic programming algorithm may be employed to determine which phonemes or words within the timed text input are to be matched with which melody segments or notes thereof. The algorithm may consider linguistic features as well as their integration with musical features. For example, the algorithm may apply the timed text input to a melody segment such that a point of repose in the music (for example, a perfect authentic cadence, commonly written as a “PAC”) is reached where there is a significant syntactic break. As another example, the algorithm may prevent breaking up stop words such as “the” with their following constituents, and may favor harmonic tension following the syntax of the text. As another example, the algorithm may favor a longer duration for words assumed to be rarer and/or harder to hear in order to optimize comprehension and musicality.

A score function may be used by the dynamic programming algorithm in some embodiments for purposes of generating the matching metric between the portion of the timed text input and melody segment. The score function may weigh individual criteria, and the weights may be automatically set, dynamically adjustable, or adjustable by a user. In one example, one criterion may be the difference between the sung phoneme length(s) and the constraints imposed by the corresponding melody segment. In some embodiments, this length criterion may account for 50% of the score function. The length criterion may consider the fit of the melody segment to the sung phoneme length as determined in act 612 (80%), as well as syntactic/stop word analysis (10%), and word rarity (10%).

Another criterion taken into account in the scoring metric may be the degree to which pauses occur between complete clauses (30%). This may be determined by using a phrase structure grammar parser to measure the minimum depth of a phrase structure parsing of the sentence at which two sequential elements in the same chunking at that level are divided by the melody. If the depth is greater than or equal to some constant determined by the phrase structure grammar parser used (for example, 4 for the open-source benepar parser), such a placement of the pause may be penalized.

Another criterion taken into account in the scoring metric may be the existence of unresolved tension only where the clause is incomplete (20%). A melody segment may be penalized where it causes a sentence or independent clause to end on the dominant or leading tone, or on a note with a duration of <1 beat.

In some examples, where none of the melody segment fit the portion of the timed text or voice input to a suitable degree, the timed text or voice input may be split into two or more subportions and the process repeated in an effort to locate one or a series of melody segments that fit each sub-portion of timed text or voice input to an acceptable degree.

In any of the foregoing examples, user preferences, requirements, and/or specifications may be taken into account. For example, the matching metrics may include or take into account a user's preference for a particular melody, a particular genre of melody, a particular speaker's voice, a degree of masculinity or femininity of a speaker's voice, an accent of a speaker's voice, a tempo, a pitch, and so forth. In some examples, such preferences may increase or decrease corresponding matching metrics. In various examples, user preferences, requirements, or specifications may override other, higher-ranked matching options. For example, if a matching metric is highest for a portion of a timed input against a first melody segment, but user preferences, requirements, or specifications specifically favor a second, different melody segment having a lower matching metric, the second melody segment may be selected in view of the user preferences, requirements, or specifications despite the lower matching metric.

Such user preferences, requirements, and/or specifications may be made with reference to a user of the transmitting device, a user of the receiving device, a combination of both, or another user. For example, where the user input received at act 604 is an electronic text-based message, such as an e-mail, the user of the transmitting device may select a particular melody, genre, speaker's voice, speaker's accent, and so forth, based upon which a patterned musical message may be generated. An e-mail application or service may, for example, include one or more plug-ins, add-ins, and so forth configured to enable a user of the e-mail application or service to input such preferences, requirements, and/or specifications. In another example, such as where the user input received at act 604 is an advertisement, an advertiser preparing the advertisement and operating the transmitting device may select a particular melody, genre, speaker's voice, speaker's accent, and so forth, based upon which a patterned musical message may be generated.

In other examples, the preferences, requirements, and/or specifications of another user, such as a user of the receiving device, may be considered in addition to, or in lieu of, those of the user of the transmitting device. In such examples, optional acts 616 and 618 may not be executed, and the receiving device may instead perform operations similar to those of acts 616 and 618 once the preferences, requirements, and/or specifications of the user of the receiving device are taken into account. In other examples, act 618 may be executed and a patterned musical message generated at act 618 may be sent to a receiving device, but the receiving device may generate a different, second patterned musical message (for example, based on preferences, requirements, and/or specifications of a user of the receiving device) to output in lieu of the patterned musical message generated at act 618.

In various examples, melody segments may be selected based on user preferences, requirements, and/or specifications in lieu of generating matching metrics. That is, rather than generating matching metrics and generating a patterned musical message based on the matching metrics, the transmitting device may instead select melody segments based on the user preferences, requirements, and/or specifications.

In some examples, at least one machine-learning and/or artificial-intelligence process may be executed to learn user preferences, including preferences of a user sending a message and a user receiving the message. For example, preferences as to genre, singer, and so forth, may be learned over time such that subsequent outputs are generated to conform to the preferred metrics, such as the preferred genre, singer, and so forth.

At optional act 618, a patterned musical message may be generated from the timed input and the plurality of melody segments based at least in part on the plurality of matching metrics. For example, each phoneme of the timed text input may be pitch-shifted according the corresponding notes(s) in the melody segment. The phoneme is set to the melody using phonetic transcription codes, such as ARPABET. The patterned musical message, with or without accompaniment, may then be output as a sound file, such as a .WAV or .MP3 file suitable for output by a playback device. In some examples, the patterned musical message may be stored (for example, in the memory 130) for future playback. The patterned musical message may be encoded with timestamps indicating a relative or absolute time at which each portion (e.g., note) of the melody is to be output. In some examples, optional act 618 is not executed.

After or concurrent with generation of the patterned musical message, visual or textual information may optionally be generated for presentation to a user to reinforce or complement the patterned musical message. For example, the transmitting device may generate graphical information for presentation on a display (such as a virtual reality or augmented reality display-enabled headset) the wording or imaging reflective of wording indicated by the patterned musical message. In some embodiments, text corresponding to a time-aligned phoneme (or the larger unit in which it is contained, such as a word or sentence) may be highlighted or otherwise visually emphasized in order to enhance comprehension or recall. Identification of the currently played phoneme may be performed with reference to a timestamp associated a respective timestamp associated with each phoneme in the patterned musical message. In some examples, characters in text being displayed may have their appearance modified in a way intended to optimize cognition and/or recall, similar to that discussed above with respect to FIG. 5.

At act 620, message information is transmitted by the transmitting device to the receiving device. The message information may be transmitted to the receiving device via a wired or wireless connection. For example, the transmitting device may include a communication interface (for example, similar or identical to the interface 190) configured to transmit information to a communication interface of the receiving device (for example, similar or identical to the interface 190). A form of the message information may vary based on the type of user input. For example, if the user input received at act 604 is in the form of an electronic message the message information may include the electronic message. In an example in which the user input is an e-mail, for example, the message information may include the e-mail text (for example, the body of the e-mail message) and other message information, such as user preferences of the transmitting-device user, one or more matching metrics, a patterned musical message, a combination of the foregoing, and so forth. In another example, where the user input received at act 604 is an advertisement, the message information may include the advertisement and other message information. For example, the advertisement may include graphical information and textual information, and the message information may further include user preferences, one or more matching metrics, a patterned musical message, a combination of the foregoing, and so forth.

Contents of the message information may vary based on whether optional acts 616 and/or 618 are executed. For example, if acts 616 and 618 are executed, then the message information may include the patterned musical message. In another example, if act 616 is executed but act 618 is not executed, then the message information may include the timed input generated at act 614 and the matching metrics generated at act 616, but not a patterned musical message. In another example, if acts 616 and 618 are not executed, then the message information may include the timed input generated at act 614, and may or may not include user preference, requirement, and/or specification information (for example, indicative of the preferences, requirements, and/or specifications of the user of the transmitting device). In still other examples, the message information may include different and/or additional information than in the examples provided above.

In some examples, the message information may be transmitted at act 620 responsive to executing act 614, act 616, or act 618. In another example, the message information may not be transmitted at act 620 until one or more transmission criteria are met. For example, where the message information includes information indicative of an advertisement, the transmitting device may not execute act 620 until the advertisement is accessed or requested by the receiving device. In one example, the transmission criteria may include a user requesting access to a webpage in which the advertisement is intended to be presented. In other examples, other transmission criteria may be contemplated.

At act 622, the receiving device receives the message information from the transmitting device. For example, the receiving device may include a communication interface configured to receive wired and/or wireless communications from one or more communicatively coupled devices, including the transmitting device. In some examples, the message information may be received from a different, intermediate device other than the transmitting device.

At optional act 624, the receiving device optionally determines one or more user preferences, requirements, and/or specifications (for example, of the user of the receiving device). The user preferences, requirements, and/or specifications may be substantially similar in nature to those discussed above with respect to acts 616 and 618, except that the preferences, requirements, and/or specifications may be those of a different user (for example, the user of the receiving device rather than the transmitting device).

In one example, the user preferences, requirements, and/or specifications may be stored in storage accessible to the receiving device, such as via a local storage (for example, similar or identical to the memory 130) or a remote storage communicatively coupled to the receiving device (for example, via the interface 190). In another example, the preferences, requirements, and/or specifications may be solicited from a user and stored and/or learned over time. In another example, the preferences, requirements, and/or specifications may be automatically learned over time. For example, the receiving device may learn various preferences, requirements, and/or specifications of the user over time as the user operates the receiving device.

Such learning may be executed in connection with one or more machine-learning algorithms, and may be based on, for example, the user's musical interests and listening habits (including, for example, preferred genres, artists, and so forth), application usage, search habits, periods of activity, geographical location, and so forth. Accordingly, where the user input received at act 604 is an advertisement, for example, the advertisement may be played back to the user of the receiving device based on the user's preferences, requirements, and/or specifications that the receiving device has learned over time. Thus, an advertiser may generate a single advertisement that is input to the transmitting device at act 604, but each user receiving the advertisement via a respective receiving device may experience the advertisement differently based on the user's preferences, requirements, and/or specifications. It is to be appreciated that a device, such as an MTD, may learn a user's preferences, requirements, and/or specifications in implementations other than those involving advertisements. Furthermore, it is to be appreciated that a device learning a user's preferences, requirements, and/or specifications may be a device other than a user device operated and/or owned by a user to whom the preferences, requirements, and/or specifications apply.

In another example, a user of the receiving device may indicate certain preferences, requirements, and/or specifications when receiving or selecting a particular message or message information for playback. For example, where the user received at act 604 is an e-mail, then the user of the receiving device may express certain preferences, requirements, and/or specifications when selecting the e-mail for playback. An e-mail application executed by the receiving device may enable a user to indicate certain preferences, requirements, and/or specifications, for example, on a message-by-message basis or for groups of messages. That is, a user may specify certain preferences, requirements, and/or specifications as each message is selected for playback, and/or may specify certain default preferences, requirements, and/or specifications as defaults for messages globally. In still other examples, optional act 624 is not executed.

At optional act 626, the receiving device optionally generates matching metrics for portions of timed inputs against melody segments. Act 626 may be substantially similar to act 616. However, act 626 may be executed based on the user preferences, requirements, and/or specifications optionally determined at act 624 and/or based on the message information received at act 622. In examples in which optional act 624 is not executed and optional act 626 is executed, generating the matching metrics at act 626 may be based on the message information received at act 622 and may be substantially similar to act 616. In other examples, act 626 is not executed.

At optional act 628, the receiving device may generate a patterned musical message. Generating the patterned musical message may be based on the message information received at act 622, and may be further based on user preferences, requirements, and/or specifications where act 624 is executed, and/or based on matching metrics generated at act 626 where act 626 is executed. For example, the patterned musical message may be generated based on a highest matching metric generated at one or both of acts 616 and 626. Accordingly, optional act 628 may be similar to act 618 but may be based on different or additional information, such as user preferences, requirements, and/or specifications optionally determined at act 624 and/or matching metrics optionally generated at act 626. In other examples, act 628 is not executed. For example, in examples in which the message information received at act 622 includes a patterned musical message generated at act 618, act 628 may not be executed.

In still other examples, act 628 may be executed even if act 618 is executed. For example, the receiving device may execute act 626 and determine that the receiving device can generate a second patterned musical message that is better than (that is, based on higher matching metrics) than the patterned musical message generated at act 618 (the “first patterned musical message”). In various examples, act 618 may always be executed to generate a first patterned musical message, and the message information may always include the first patterned musical message. However, the receiving device may determine that a second patterned musical message generated at act 628 should be output (at act 632, discussed below) in lieu of the first patterned musical message. The receiving device may make such a determination before or after generating the second patterned musical message. The receiving device may make such a determination based on matching metrics generated at act 626 and, in some examples, matching metrics generated at act 616 and received by the receiving device at act 622.

At optional act 630, the receiving device may store one or more patterned musical messages. For example, the receiving device may store a first patterned musical message generated at act 618 and received at act 622, and/or may store a second patterned musical message generated at act 628. The receiving device may store any patterned musical messages in memory or storage (for example, the memory 130), which may be local to or remote from the receiving device. In some examples, the receiving device may store a first patterned musical message received at act 622 even if the receiving device does not output the first patterned musical message (at act 632, discussed below) and instead outputs a second patterned musical message generated at act 628. In other examples, the receiving device may only store a patterned musical message (for example, the first or second patterned musical message) that is to be output at act 632. In still other examples, act 630 is not executed.

At act 631, a determination is made as to whether a patterned musical message is to be output. The patterned musical message to be output may be either the first patterned musical message, which may optionally have been generated at act 618 in some examples, or the second patterned musical message, which may optionally have been generated at act 628 in some examples. In some examples, a determination may be made that the patterned musical message is to be output in real-time responsive to receiving a patterned musical message in the message information at act 622, or responsive to generating a patterned musical message at act 628. In other examples, a determination may be made that the patterned musical message is to be output in non-real-time with respect to acts 622 and 628. For example, where optional act 630 is executed, the receiving device may store the patterned musical message until one or more playback criteria are met, responsive to which the patterned musical message may be output. If the playback criteria are not met, then the patterned musical message is not to be output yet (631 NO), and the process 600 returns to act 631. Act 631 is repeatedly executed until the playback criteria are met and a determination is thus made that the patterned musical message is to be output (631 YES), responsive to which the process 600 continues to act 632. In various examples, if act 631 includes any playback criteria beyond simply receiving or generating the patterned musical message to be output, then the transmitting and receiving devices may be considered to be operating in a non-real-time mode of operation.

In one example in which the patterned musical message is generated based on an electronic message, such as an e-mail, the patterned musical message which is indicative of the e-mail may be received at act 622 or generated at act 628. However, the receiving device may determine that the patterned musical message is not to be output immediately (631 NO). For example, the receiving device may store the patterned musical message at act 630, and await a user request to playback the patterned musical message. Accordingly, act 631 may be repeatedly executed until the user request is received (631 YES). The user may input the user request by, for example, selecting the received e-mail in an e-mail application executed by the receiving device, responsive to which the receiving device may output the patterned musical message indicative of the e-mail. Even if the user immediately selects the e-mail for playback upon receiving the e-mail, the receiving device may be considered to be operating in a non-real-time mode because of the playback criteria (that is, the requirement for a user to select the e-mail for playback). This may be considered non-real-time operation inasmuch as additional criteria must be satisfied (for example, the user of the receiving device selecting the e-mail for playback) after the patterned musical message is received or generated for the patterned musical message to be output, such that a non-negligible time delay is introduced between generating or receiving the patterned musical message and outputting the patterned musical message.

In another example in which the patterned musical message is generated based on an advertisement, the patterned musical message indicative of the advertisement may be received at act 622 or generated at act 628. Act 631 may include determining whether one or more playback criteria are met. The one or more criteria may include, for example, a user navigating to a webpage in which the advertisement is embedded, a user navigating to a specific portion of a webpage in which the advertisement appears, a user selecting the advertisement for playback, and so forth.

In another example in which the patterned musical message is generated based on an advertisement, the patterned musical message may be output responsive to receiving the patterned musical message at act 622 or generating the patterned musical message at act 628. For example, act 620 may be executed responsive to a user of the receiving device accessing a webpage in which an advertisement is to be presented. The receiving device may receive the message information at act 622 and determine that the patterned musical message is to be output responsive to receiving the message information at act 622 or generating the patterned musical message at act 628. In still other examples, the patterned musical message may be output responsive to additional or different criteria being met.

At act 632, the receiving device outputs a patterned musical message responsive to determining that the patterned musical message is to be output (631 YES). As indicated above, the patterned musical message output at act 632 may be either the first patterned musical message, which may optionally have been generated at act 618 in some examples, or the second patterned musical message, which may optionally have been generated at act 628 in some examples. The patterned musical message may be output in an acoustic signal as discussed above. For example, the receiving device may include one or more acoustic speakers or other outputs (for example, the speaker/output 140) configured to output an acoustic signal.

In various examples, the receiving device may not output the patterned musical message as an acoustic signal. For example, the receiving device may output an electrical signal encoding the patterned musical message to another device for storage and/or playback as an acoustic signal.

At act 634, the process 600 ends.

Examples of the process 600 are provided for purposes of explanation. In a first example, a transmitting user operating a transmitting device desires to send an e-mail to a receiving user operating a receiving device. The transmitting device and/or receiving device may be, for example, a musical translation device, a laptop computer, a smartphone, and so forth, each executing an e-mail application. The transmitting user may use the e-mail application to draft and send an e-mail to the receiving user, and the receiving user may use the e-mail application to receive and output the e-mail.

In some examples, the transmitting device may solicit user preferences from the transmitting user regarding how a patterned musical message should be generated. For example, the transmitting device may enable the transmitting user to select a preferred melody, genre, speaker's voice, and so forth, based on which a patterned musical message is generated. An e-mail application may include one or more plug-ins, add-ins, or other modules that enable the transmitting user to provide input towards generating a patterned musical message.

In another example, the transmitting device may learn preferences of the transmitting user as the transmitting user operates the transmitting device. For example, if the transmitting user frequently uses the transmitting device to listen to classical music, then the transmitting device may learn that the transmitting user has a preference for classical music, and may execute any of acts 616-620 at least partially based on the user's preference.

At act 604, the transmitting user provides a user input including the e-mail. Act 604 may be executed responsive to the transmitting user selecting a “Send E-Mail” button, for example, or may be executed in real- or near-real-time as the transmitting user drafts the e-mail. The user input may further include the user's preferences or other information. Acts 604-614 are executed with respect to the e-mail body to generate a timed text input based on the e-mail body. In examples in which optional act 616 is executed, matching metrics may be generated between the timed text input and one or more melody segments.

The matching metrics may be based on user preferences, such as in examples in which the transmitting user's preferences are considered. In some examples, the receiving user's preferences may be considered. For example, the e-mail received at act 604 may indicate one or more intended recipients of the e-mail. The transmitting device, or a device coupled thereto, may include information indicative of preferences of the intended recipients.

In examples in which optional act 618 is executed, a patterned musical message may be generated based on the e-mail body, and optionally based on user preferences of the transmitting user, receiving user, a combination of both, or other users.

At act 620, message information is transmitted from the transmitting device to the receiving device. The message information may be transmitted responsive to all of the acts 604-618 that are to be executed being successfully executed once the transmitting user selects a “Send E-Mail” button, for example. The message information includes at least the e-mail body, and may optionally further include preferences of the transmitting user, one or more matching metrics, a patterned musical message, and so forth. The message information may be sent from a communication interface of the transmitting device (for example, a wired or wireless interface) to a communication interface of the receiving device (for example, a wired or wireless interface) via one or more communication networks, such as the Internet. The receiving device receives the message information at act 622.

In examples in which optional act 624 is executed, the receiving device may determine one or more user preferences, requirements, and/or specifications of the receiving user. For example, the receiving device may solicit or learn preferences of the receiving user over time. Preferences may be solicited from the user by providing a module (for example, a plug-in or add-in) in an e-mail application executed by the receiving device that enables the receiving user to express certain preferences. In some examples, a third party other than the receiving user, such as a caretaker or physician, may provide user preferences, requirements, and/or specifications to the receiving device. In other examples, act 624 is not executed.

In examples in which optional act 626 is executed, the receiving device may generate one or more matching metrics for the timed text input (indicative of the e-mail body) received at act 622 against one or more melody segments. For example, the receiving device may generate the one or more matching metrics based on the message information, which may include user preferences, requirements, and/or specifications regarding the transmitting user, and/or based on user preferences, requirements, and/or specifications of the receiving user optionally determined at optional act 624.

In examples in which optional act 628 is executed, the receiving device may generate a patterned musical message. The patterned musical message may be generated based on a melody segment having a highest matching metric, which may have been provided by the transmitting device at act 622 or generated by the receiving device at act 626. In other examples, act 628 is not executed, such as examples in which a patterned musical message was generated at act 618 and provided to the receiving device at act 622.

In examples in which optional act 630 is executed, the receiving device may store the patterned musical message. For example, the receiving device may store the message in a local or remote storage or memory.

At act 631, the receiving device determines whether to output a patterned musical message. Act 631 may include determining whether one or more playback criteria are satisfied. For example, playback criteria may include the receiving user using the e-mail application executed by the receiving device to select the e-mail for playback. Until the receiving user selects the e-mail for playback, the playback criteria may be considered unsatisfied (631 NO), and the receiving device will not output the patterned musical message at act 632 until the user selects the e-mail for playback. Responsive to the playback criteria being satisfied (631 YES), the process 600 continues to act 632.

At act 632, the receiving device outputs the patterned musical message. The receiving device may include one or more speakers configured to output a patterned musical message, which may be based on the e-mail. For example, where the receiving device is a laptop computer or smartphone, speakers coupled to the laptop computer or smartphone may output acoustic signals based on the patterned musical message to convey the contents of the e-mail to the receiving user. The process 600 ends at act 634.

Accordingly, executing the process 600 enables a first user to send a text-based e-mail to a second user, and a patterned musical message may be played back to the second user to convey the contents of the e-mail to the second user. In a second example, an advertiser operating a transmitting device, referred to as a transmitting user, wishes to send an advertisement including text to a consumer operating a receiving device, referred to as a receiving user. The transmitting device and/or receiving device may be, for example, a musical translation device, a laptop computer, a smartphone, and so forth. The receiving device may be accessing a webpage that includes an advertisement. The transmitting device may send the advertisement to the receiving device, either directly or via one or more intermediary devices, and the receiving device may output the advertisement to the receiving user.

In some examples, the transmitting device may solicit user preferences from the transmitting user regarding how a patterned musical message should be generated. For example, the transmitting device may enable the transmitting user to select a preferred melody, genre, speaker's voice, and so forth, based on which a patterned musical message is generated.

In another example, the transmitting device may learn preferences of the transmitting user as the transmitting user operates the transmitting device. For example, if the transmitting user frequently prepares advertisements for American consumers in a particular region of the United States, then the transmitting device may learn that the transmitting user has a preference for patterned musical messages employing speakers with accents typical of that particular region of the United States, and may execute any of acts 616-620 at least partially based on the user's preferences.

At act 604, the transmitting user provides a user input including an advertisement. The advertisement, in turn, includes text, which may be in addition to graphical elements. The user input may further include the transmitting user's preferences, requirements, specifications, or other information. Acts 604-614 are executed with respect to the textual content of the advertisement to generate a timed text input based on the textual content. In examples in which optional act 616 is executed, matching metrics may be generated between the timed text input and one or more melody segments.

The matching metrics may be based on user preferences, such as in examples in which the transmitting user's preferences are considered. In some examples, the receiving user's, or users', preferences may be considered. For example, the advertisement received at act 604 may indicate one or more demographics of consumers to whom the advertisement is directed. The transmitting device, or a device coupled thereto, may include information indicative of preferences of the intended recipients of the advertisement.

In examples in which optional act 618 is executed, a patterned musical message may be generated based on the textual content of the advertisement, and optionally based on user preferences of the transmitting user, receiving user, a combination of both, or other users.

At act 620, message information is transmitted from the transmitting device to, in some examples, the receiving device. In other examples, the message information may be transmitted to one or more intermediary devices prior to being provided to the receiving device. The message information may be transmitted responsive to all of the acts 604-618 that are to be executed being successfully executed once the transmitting user initiates the release of the advertisement, for example. The message information includes at least the advertisement, including textual and/or graphical content thereof, and may optionally further include preferences of the transmitting user, one or more matching metrics, a patterned musical message, and so forth. The message information may be sent from a communication interface of the transmitting device (for example, a wired or wireless interface) to a communication interface of the receiving device (for example, a wired or wireless interface) via one or more communication networks, such as the Internet. In other examples, the message information may be sent from a communication interface of the transmitting device to a communication interface of an external server, for example, configured to host web content, such as web-based advertisements, to be hosted for one or more end-users, such as the receiving user. At a subsequent point in time, such as when the receiving device requests webpage information from the server hosting the web content, the server may provide the message information to the receiving device. The receiving device receives the message information at act 622.

In examples in which optional act 624 is executed, the receiving device may determine one or more user preferences, requirements, and/or specifications of the receiving user. For example, the receiving device may solicit or learn preferences of the receiving user over time. The user preferences may be learned based on what type of advertisements the user engages with most often, for example. In another example, the user preferences may be learned based on musical preferences of the receiving user. In some examples, a third party other than the receiving user, such as a caretaker or physician, may provide user preferences, requirements, and/or specifications to the receiving device. In other examples, act 624 is not executed.

In examples in which optional act 626 is executed, the receiving device may generate one or more matching metrics for the timed text input (indicative of the textual content of the advertisement) received at act 622 against one or more melody segments. For example, the receiving device may generate the one or more matching metrics based on the message information, which may include user preferences, requirements, and/or specifications regarding the transmitting user, and/or based on user preferences, requirements, and/or specifications of the receiving user optionally determined at optional act 624.

In examples in which optional act 628 is executed, the receiving device may generate a patterned musical message. The patterned musical message may be generated based on a melody segment having a highest matching metric, which may have been provided by the transmitting device at act 622 or generated by the receiving device at act 626. In other examples, act 628 is not executed, such as examples in which a patterned musical message was generated at act 618 and provided to the receiving device at act 622.

In examples in which optional act 630 is executed, the receiving device may store the patterned musical message. For example, the receiving device may store the message in a local or remote storage or memory.

At act 631, the receiving device determines whether to output a patterned musical message. Act 631 may include determining whether one or more playback criteria are satisfied. For example, the playback criteria may include the receiving user accessing a webpage that includes the advertisement, which may be played back or displayed when a user accesses the webpage, a specific portion of the webpage, selects the advertisement for playback on the webpage, and so forth. Until the receiving user satisfies one or more applicable criteria, the playback criteria may be considered unsatisfied (631 NO), and the receiving device will not output the patterned musical message at act 632 until the user satisfies the criteria. Responsive to the playback criteria being satisfied (631 YES), the process 600 continues to act 632.

At act 632, the receiving device outputs the patterned musical message. The receiving device may include one or more speakers configured to output a patterned musical message, which may be based on the textual content of the advertisement. For example, where the receiving device is a laptop computer or smartphone, speakers coupled to the laptop computer or smartphone may output acoustic signals based on the patterned musical message to convey the textual contents of the advertisement to the receiving user. The process 600 ends at act 634.

Accordingly, a user input received at a first device may be used to generate a patterned musical message that is played back to a user by another, second device. The first device, second device, or a third, intermediary device may generate the patterned musical message. The patterned musical message may be generated based on preferences, requirements, and/or specifications of one or more users. The patterned musical message may be stored and played back in non-real-time with respect to a time at which the patterned musical message is generated, although the patterned musical message may also be played back in real- or near-real-time in some examples. In one non-limiting example, a patterned musical message may be generated based on an e-mail. In another non-limiting example, a patterned musical message may be generated based on an advertisement. In various other examples, a patterned musical message may be generated based on other user inputs involving one or more devices.

Various examples are within the scope of the disclosure. For example, and with reference to the process 600, in some examples a transmitting device may store and/or output as an audible signal a patterned musical message optionally generated at act 618. The transmitting device may do so in addition to, in lieu of, prior to, and/or after transmitting the message information to the receiving device at act 620.

It is to be appreciated that the transmitting device may execute acts 606-620 (some of which may be optionally not executed) substantially in real-time responsive to receiving an input at act 604. Similarly, the receiving device may execute acts 624-630 (some of which may be optionally not executed) substantially in real-time responsive to receiving message information at act 622. However, in these examples, the transmitting and receiving devices may be considered to be operating in a non-real-time mode of operation at least because a patterned musical message optionally generated at either or both of acts 618 and 628 may not be output in real-time responsive to the optional execution of acts 618 and/or 628. For example, the receiving device may be considered to be operating in a non-real-time mode of operation in examples in which act 632 is not executed in real-time in response to a first patterned musical message being received at act 622 or in response to a second patterned musical message being generated at act 628. Rather, act 632 may be executed in response to one or more additional playback criteria being met at act 631, as discussed above.

### Exemplary Computer Implementations

Processes described above are merely illustrative embodiments of systems that may be used to execute methods for transposing spoken or textual input to music. Such illustrative embodiments are not intended to limit the scope of the present invention, as any of numerous other implementations exist for performing the invention. None of the embodiments and claims set forth herein are intended to be limited to any particular implementation of transposing spoken or textual input to music, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Python, Javascript, Visual Basic, C, C#, or C++, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

The computer system may include specially programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. A computer system may be also implemented using specially programmed, special purpose hardware. In a computer system there may be a processor that is typically a commercially available processor such as the Pentium class processor available from the Intel Corporation. Many other processors are available. Such a processor usually executes an operating system which may be, for example, any version of the Windows, iOS, Mac OS, or Android OS operating systems, or UNIX/LINUX available from various sources. Many other operating systems may be used. A device implementation, such as the MTD implementation, may also rely on a commercially available embedded device, such as an Arduino or Raspberry Pi device.

Some aspects of the invention may be implemented as distributed application components that may be executed on a number of different types of systems coupled over a computer network. Some components may be located and executed on mobile devices, servers, tablets, or other system types. Other components of a distributed system may also be used, such as databases or other component types.

The processor and operating system together define a computer platform for which application programs in high-level programming languages are written. It should be understood that the invention is not limited to a particular computer system platform, processor, operating system, computational set of algorithms, code, or network. Further, it should be appreciated that multiple computer platform types may be used in a distributed computer system that implement various aspects of the present invention. Also, it should be apparent to those skilled in the art that the present invention is not limited to a specific programming language, computational set of algorithms, code or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). Certain aspects of the present invention may also be implemented on a cloud-based computer system (e.g., the EC2 cloud-based computing platform provided by Amazon.com), a distributed computer network including clients and servers, or any combination of systems.

It should be appreciated that the invention is not limited to executing on any particular system or group of systems. Also, it should be appreciated that the invention is not limited to any particular distributed architecture, network, or communication protocol.

Further, on each of the one or more computer systems that include one or more components of device 100, each of the components may reside in one or more locations on the system. For example, different portions of the components of device 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

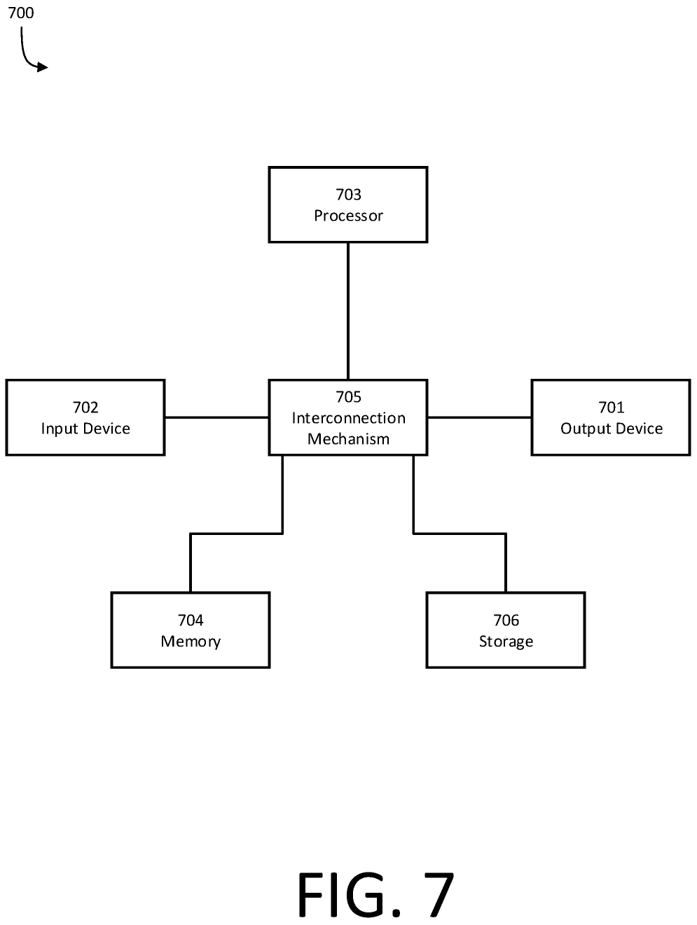

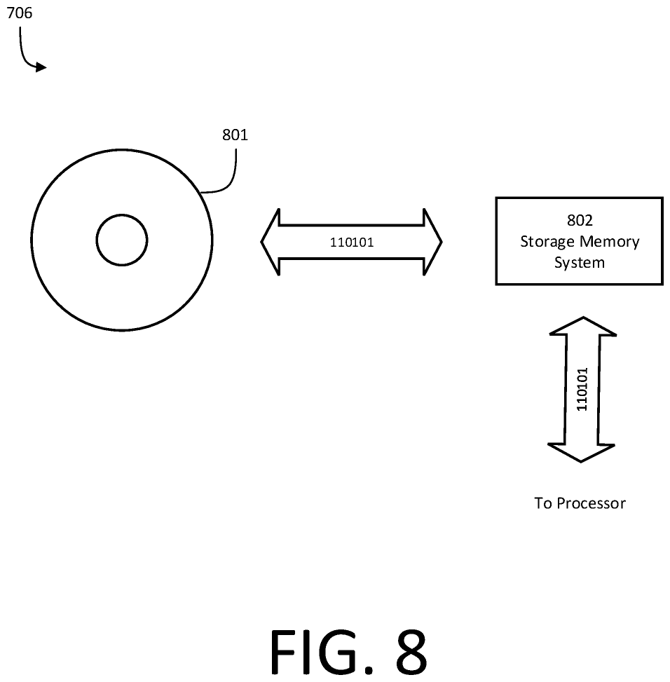

A musical translation device, such as the MTD 100 or the transmitting or receiving devices discussed above with respect to the process 700, may be implemented on a computer system described below in relation to FIGS. 7 and 8. In particular, FIG. 7 shows an example computer system 700 used to implement various aspects. FIG. 8 shows an example storage system that may be used.

System 700 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the recited devices and systems with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 700 such as that shown in FIG. 7. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, and/or speaker. In addition, computer system 700 may contain one or more interfaces (not shown) that connect computer system 700 to a communication network (in addition or as an alternative to the interconnection mechanism 705).

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a dynamic random-access memory (DRAM) or static memory (SRAM).

Data may be located in storage system 706, as shown, or in memory system 704. The processor 703 generally manipulates the data within the integrated circuit memory 704, 702 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components than that shown in FIG. 7.

Computer system 700 may be a general-purpose computer system that is programmable using a high-level computer programming language. Computer system 700 may be also implemented using specially programmed, special purpose hardware. In computer system 700, processor 703 is typically a commercially available processor such as the Pentium, Core, Core Vpro, Xeon, or Itanium class processors available from the Intel Corporation. Many other processors are available. Such a processor usually executes an operating system which may be, for example, operating systems provided by Microsoft Corporation or Apple Corporation, including versions for PCs as well as mobile devices, iOS, Android OS operating systems, or UNIX available from various sources. Many other operating systems may be used.

Various embodiments of the present invention may be programmed using an object-oriented programming language, such as SmallTalk, Python, Java, C++, Ada, or C#(C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the Common Gateway Interface (CGI) script, PHP Hyper-text Preprocessor (PHP), Active Server Pages (ASP), HyperText Markup Language (HTML), Extensible Markup Language (XML), Java, JavaScript and open source libraries for extending Javascript, Asynchronous JavaScript and XML (AJAX), Flash, and other programming methods. Further, various aspects of the present invention may be implemented in a cloud-based computing platform, such as the EC2 platform available commercially from Amazon.com (Seattle, WA), among others. Various aspects of the invention may be implemented as programmed or non-programmed elements, or any combination thereof.

### Methods of Use

Described herein are musical translation devices and related software suitable for receiving input (e.g., a text, audio or spoken message) containing information to be conveyed, and converting that input to a patterned musical message (e.g., a song or melody) to treat an indication in a user, such as a disease, disorder, or condition described herein. The user may have a cognitive impairment, a behavioral impairment, or a learning impairment. The cognitive impairment, behavioral impairment, or learning impairment may be chronic (e.g., lasting for more than 1 month, 2 months, 3 months, 6 months, 1 year, 2 years, 5 years, or longer) or acute (e.g., lasting for less than 2 years, 1 year, 6 months, 4 months, 2 months, 1 month, 2 weeks, 1 week, or less). Exemplary diseases, disorders, or conditions, such as cognitive, behavioral, or learning impairments, in a user include autism spectrum disorder, attention deficit disorder, attention deficit hyperactivity disorder, aphasia, dementia, dyslexia, dysphasia, apraxia, stroke, traumatic brain injury, schizophrenia, schizoaffective disorder, depression, bipolar disorder, post-traumatic stress disorder, Alzheimer's disease, Parkinson's disease, Down's syndrome, Prader Willi syndrome, Smith Magenis syndrome, age-related cognitive impairment, learning disability, an intellectual disability, anxiety, stress, brain surgery, surgery, and a language comprehension impairment or other neurological or behavioral disorder.

In one example, the musical-translation devices discussed herein may advantageously aid users with diseases, disorders, and/or conditions such as autism-spectrum disorder at least in part by increasing attention, focus, and understanding of a user. Example musical-translation devices may advantageously motivate individuals having autism-spectrum disorder, for example, to speak through song, where the user can repeat parts, words, or all of a song. In another example, example musical-translation devices may advantageously aid users with receptive aphasia to understand the meaning of a text and/or voice message, and may aid users with expressive aphasia in learning to speak by copying parts or all of a song. Example musical-translation devices may also assist users in improving articulation by learning to repeat selected sung phonemes, syllables, and/or phrases. As discussed above, treatment may be enhanced for individuals by implementing machine-learning and/or artificial-intelligence algorithms to learn user preferences over time.

It will be appreciated that a musical translation device and related software described herein can be used to enhance communication and interaction between a user and the user's family members, care providers, and the like. For example, the musical translation device may be used to convey important information to a user who is at least partially self-reliant, including information about medical and other appointments, nutrition, clothing, personal and general news, and the like.

It will also be appreciated that a musical translation device and related software described herein can be used to provide training in musical therapy, such as for users having dyslexia or aphasia. Standardized training modules may be developed and presented to the user to allow for standardized, uniform therapy, and to allow caretakers and medical personnel to measure the clinical benefit to the user. A user may also use the musical translation device as a musical therapy device, such as a user having expressive aphasia who needs to re-learn how to speak.

It will be appreciated that a musical translation device and related software described herein can be used by a user in combination with an additional treatment. The additional treatment may be a pharmaceutical agent (e.g., a drug) or a therapy, such as speech language therapy, physical therapy, occupational therapy, psychological therapy, neurofeedback, diet alteration, cognitive therapy, academic instruction and/or tutoring, exercise, and the like. In an embodiment, the additional treatment employed may achieve a desired effect for the same disease, disorder, or condition, or may achieve a different effect. The additional treatment may be administered simultaneously with use of the musical translation device, or may be administered before or after use of the musical translation device. Exemplary pharmaceutical agents administered in combination with use of the musical translation device include a pain reliever (e.g., aspirin, acetaminophen, ibuprofen), an antidepressant (e.g., citalopram, escitalopram, fluoxetine, fluvoxamine, paroxetine, sertraline, trazodone, nefazodone, vilazodone, vortioxetine, duloxetine, venlafaxine), an antipsychotic (e.g., paliperidone, olanzapine, risperidone, or aripiprazole), a dopamine analog (e.g., levodopa or carbidopa), a cholinesterase inhibitor (e.g., donepezil, galantamine, or rivastigmine), a stimulant (e.g., dextroamphetamine, dexmethylphenidate, methylphenidate), or a vitamin or supplement. In some cases, use of a musical translation device by a user may result in a modified (e.g., reduced) dosage of a pharmaceutical agent required to achieve a desired therapeutic effect. For example, a user receiving treatment for depression with an anti-depressant may require a lower dosing regimen of said anti-depressant during or after treatment with a musical translation device.

Autism spectrum disorder (ASD) affects communication and behavior in an individual. A person affected with ASD may have difficulty in communication and interaction with other people, restricted interests, repetitive behaviors, or exhibit other symptoms that may affect his or her ability to function properly and assimilate into society. In an embodiment, a user with ASD may be treated with a musical translation device described herein. A user having ASD may be further administered a treatment for irritability or another symptom of ASD, such as aripiprazole or risperidone. In an embodiment, the dosage of aripiprazole or risperidone administered to a user with ASD is between 0.1 mg and 50 mg. In an embodiment, a user with ASD is administered aripiprazole or risperidone in conjunction with using a musical translation device described herein, which may result in a modified (e.g., reduced) dosing regimen to attain a beneficial therapeutic effect.

Attention deficit disorder (ADD) and attention deficit hyperactivity disorder (ADHD) are disorders marked by a pattern of inattention or hyperactivity/impulsivity that interferes with daily life. For example, an individual with ADD or ADHD may exhibit a range of behavioral problems, such as difficulty attending to instruction or focusing on a task. In an embodiment, a user with ADD and/or ADHD may be treated with a musical translation device described herein. A user having ADD or ADHD may further be administered a treatment, such as methylphenidate (Ritalin) or a mixed amphetamine salt (Adderall or Adderall XR), to reduce or alleviate a symptom of the disorder. The dosage of methylphenidate or a mixed amphetamine salt administered to a user is between 5 mg and 100 mg. In an embodiment, a user with ADD or ADHD is administered methylphenidate or a mixed amphetamine salt in conjunction with using a musical translation device described herein which may result in a modified (e.g., reduced) dosing regimen to attain a beneficial therapeutic effect.

Depression is a mood disorder resulting in a persistent feeling of sadness and/or loss of interest in daily activities. It often presents with low self-esteem, fatigue, headaches, digestive problems, or low energy, and may negatively impact one's life by affecting personal and professional relationships and general health. In an embodiment, a user with depression may be treated with a musical translation device described herein. A user with depression may further be administered a treatment to reduce or alleviate a symptom of the disease, such as a selective serotonin reuptake inhibitor (SSRI), e.g., citalopram (Celexa), escitalopram (Lexapro), fluoxetine (Prozac), fluvoxamine (Luvox), paroxetine (Paxil), or sertraline (Zoloft). In an embodiment, the dosage of citalopram, escitalopram, fluoxetine, fluvoxamine, paroxetine, or sertraline administered to a user is between 0.1 mg and 250 mg. In an embodiment, a user with depression is administered citalopram, escitalopram, fluoxetine, fluvoxamine, paroxetine, or sertraline in conjunction with using a musical translation device described herein which may result in a modified (e.g., reduced) dosing regimen to attain a beneficial therapeutic effect.

Bipolar disorder is a condition causing extreme mood swings ranging from mania to depression in an individual, including periods of both depression and abnormally elevated mood. In an embodiment, a user with bipolar disorder may be treated with a musical translation device described herein. A user with bipolar disease may further be administered a treatment to reduce or alleviate a symptom of the disease, such as lithium carbonate, divalproex, and lamotrigine. In an embodiment, the dosage of lithium carbonate, divalproex, and lamotrigine administered to a user is between 100 mg and 5 g. In an embodiment, a user with bipolar disorder is administered lithium carbonate, divalproex, and lamotrigine in conjunction with using a musical translation device described herein which may result in a modified (e.g., reduced) dosing regimen to attain a beneficial therapeutic effect.

Alzheimer's disease is a progressive neurological degenerative disease believed to be caused by the formation of beta-amyloid plaques in the brain that result in an impairment of memory, cognition, and other thinking skills. In an embodiment, a user with Alzheimer's disease may be treated with a musical translation device described herein. A user with Alzheimer's disease may further be administered a treatment to reduce or alleviate a symptom of the disease, such as a cholinesterase inhibitor (e.g., donepezil, galantamine, or rivastigmine). In an embodiment, the dosage of donepezil, galantamine, or rivastigmine administered to a user is between 0.1 mg and 100 mg. In an embodiment, a user with Alzheimer's disease is administered donepezil, galantamine, or rivastigmine in conjunction with using a musical translation device described herein which may result in a modified (e.g., reduced) dosing regimen to attain a beneficial therapeutic effect.

Parkinson's disease is a progressive neurodegenerative disorder that primarily affects the dopamine-producing neurons in the brain, resulting in tremors, stiffness, imbalance, and impairment in movement. In an embodiment, a user with Parkinson's disease may be treated with a musical translation device described herein. A user with Parkinson's disease may further be administered a treatment to reduce or alleviate a symptom of the disease, such as levodopa or carbidopa. In an embodiment, the dosage of levodopa or carbidopa administered to a user is between 1 mg and 100 mg. In an embodiment, a user with Parkinson's disease is administered levodopa or carbidopa in conjunction with using a musical translation device described herein which may result in a modified (e.g., reduced) dosing regimen to attain a beneficial therapeutic effect.

Schizophrenia is a disorder that affects the perception of the affected, often resulting in hallucinations, delusions, and severely disoriented thinking and behavior. In an embodiment, a user with schizophrenia may be treated with a musical translation device described herein. A user with schizophrenia may further be administered a treatment to reduce or alleviate a symptom of the disorder, such as haloperidol, olanzapine, risperidone, quetiapine, or aripiprazole. In an embodiment, the dosage of haloperidol, olanzapine, risperidone, quetiapine, or aripiprazole administered to a user is between 1 mg and 800 mg. For example, in an embodiment, a user with schizophrenia is administered haloperidol, olanzapine, risperidone, quetiapine, or aripiprazole in conjunction with using a musical translation device described herein which may result in a modified (e.g., reduced) dosing regimen to attain a beneficial therapeutic effect.

Schizoaffective disorder is a condition in which an individual experiences symptoms of schizophrenia coupled with a mood disorder, such as bipolar disorder or depression. In an embodiment, a user with schizoaffective disorder may be treated with a musical translation device described herein. A user with schizoaffective disorder may further be administered a treatment to reduce or alleviate a symptom of the disease, such as paliperidone or another first- or second-generation antipsychotic, possibly with the addition of an anti-depressant. In an embodiment, the dosage of anti-psychotic and/or anti-depressant administered to a user is between 0.5 mg and 50 mg. In an embodiment, a user with schizoaffective disorder is administered paliperidone or another first- or second-generation antipsychotic in conjunction with using a musical translation device described herein which may result in a modified (e.g., reduced) dosing regimen to attain a beneficial therapeutic effect.

The device may be used in conjunction with an additional agent to achieve a synergistic effect. For example, in the case of a user having schizophrenia, use of the device with an anti-psychotic agent may allow for lowering of the dose of anti-psychotic agent in the user (e.g., relative to the dose of the anti-psychotic prescribed prior to use of the device). In another example, use of the device with an anti-psychotic agent may reduce persistent symptoms of schizophrenia that have continued despite optimizing the anti-psychotic medication regimen.

A user with a disease, disorder, or condition described herein may be diagnosed or identified as having the disease, disorder, or condition. In an embodiment, the user has been diagnosed by a physician. In an embodiment, the user has not been diagnosed or identified as having a disease, disorder, or condition. In these cases, the user may have one or more symptoms of a cognitive impairment, a behavioral impairment, or a learning impairment (e.g., as described herein) but has not received a diagnosis, e.g., by a physician.

In an embodiment, a user may be either a male or female. In an embodiment, the user is an adult (e.g., over 18 years of age, over 35 years of age, over 50 years of age, over 60 years of age, over 70 years of age, or over 80 years of age). In an embodiment, the user is a child (e.g., less than 18 years of age, less than 10 years of age, less than 8 years of age, less than 6 years of age, or less than 4 years of age).

While the embodiments discussed above relate to translating words or text to song in order to facilitate word or syntax comprehension or memory, other methods of use should be understood to be within the scope of this disclosure. For example, in many current video games, including RPGs (role-playing games), action games, simulation games, and strategy games, users are presented with dialog with other characters in the game, with a narrator, or as a set of instructions on how to play the game. In one embodiment, the musical translation device may be used by game developers to convert whatever text is presented in the game to song during the course of gameplay, and for instructions and aspects of setting up and running the game. Such an embodiment may provide enhanced enjoyment of the game for both users with and without disorders. In addition, it may increase accessibility of these videogames to users with language- or text-related impairments as described above.

In another example, it will be appreciated that virtual digital assistants (e.g., Alexa by Amazon) are often interacted with, in homes and businesses, through devices such as smart speakers. Such virtual assistants may be modified according to aspects described herein to respond through song to the respondent, rather than through spoken voice, to allow optimal comprehension of the system's response, thereby returning information on products music, news, weather, sports, home system functioning and more to a person in need of song for optimal comprehension and functioning.

In other examples, the principles discussed herein may be implemented to aid individuals with vision and/or hearing impairments. In still other examples, the principles discussed herein may be implemented independent of any impairment that a user may or may not have. For example, a user may use a musical-translation device in the manner discussed above simply for enjoyment or personal preference, regardless of any impairment that the user may or may not have.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of transforming textual input to a musical score comprising:
receiving, by a first device, text input;
transliterating the text input into a standardized phonemic representation of the text input;
determining, for the phonemic text input, a plurality of spoken pause lengths and a plurality of spoken phoneme lengths;
mapping the plurality of spoken pause lengths to a respective plurality of sung pause lengths;
mapping the plurality of spoken phoneme lengths to a respective plurality of sung phoneme lengths;
generating, from the plurality of sung pause lengths and the plurality of sung phoneme lengths, a timed text input; and
transmitting, by the first device, message information including the timed text input to a second device such that the second device outputs a patterned musical message indicative of the text input based on the message information.

2. The method of claim 1, further comprising generating, by the first device, a plurality of matching metrics for each of a respective plurality of portions of the timed text input against a plurality of melody segments, wherein the message information includes the plurality of matching metrics.

3. The method of claim 2, further comprising generating, by the first device, the patterned musical message from the timed text input and the plurality of melody segments based at least in part on the plurality of matching metrics, wherein the message information includes the patterned musical message.

4. The method of claim 1, further comprising generating, by the second device, a plurality of matching metrics for each of a respective plurality of portions of the timed text input against a plurality of melody segments based on the message information.

5. The method of claim 4, further comprising generating, by the second device, the patterned musical message from the timed text input and the plurality of melody segments based at least in part on the plurality of matching metrics.

6. The method of claim 1, further comprising determining, by the second device, at least one of a preference, requirement, or specification of a user of the second device.

7. The method of claim 6, further comprising generating a plurality of matching metrics for each of a respective plurality of portions of the timed text input against a plurality of melody segments based on the message information and the at least one of the preference, requirement, or specification of the user of the second device.

8. The method of claim 7, further comprising generating, by the second device, the patterned musical message from the timed text input based at least in part on the plurality of melody segments.

9. The method of claim 1, further comprising determining, by the first device, at least one of a preference, requirement, or specification of a user of the first device.

10. The method of claim 9, further comprising generating a plurality of matching metrics for each of a respective plurality of portions of the timed text input against a plurality of melody segments based on the at least one of the preference, requirement, or specification of the user of the first device.

11. The method of claim 10, further comprising generating the patterned musical message from the timed text input based at least in part on the plurality of melody segments.

12. The method of claim 1, wherein receiving the text input includes receiving an electronic message including the text input.

13. The method of claim 12, wherein the electronic message is an e-mail message.

14. The method of claim 1, wherein receiving the text input includes receiving an advertisement comprising the text input.

15. The method of claim 1, further comprising storing, by the second device, the patterned musical message.

16. The method of claim 1, wherein the method is performed in non-real-time, and further comprises causing the patterned musical message to be played audibly on a transducer.

17. The method of claim 1, wherein the patterned musical message is presented to a user having a cognitive impairment, a behavioral impairment, or a learning impairment.

18. The method of claim 17, wherein the user has a comprehension disorder, including at least one of autism spectrum disorder, attention deficit disorder, attention deficit hyperactivity disorder, aphasia, dementia, dyspraxia, dyslexia, dysphasia, apraxia, stroke, traumatic brain injury, brain surgery, surgery, schizophrenia, schizoaffective disorder, depression, bipolar disorder, post-traumatic stress disorder, Alzheimer's disease, Parkinson's disease, age-related cognitive impairment, a language comprehension impairment, an intellectual disorder, a developmental disorder, stress, anxiety, Williams syndrome, Prader Willi syndrome, Smith Magenis syndrome, Bardet Biedl syndrome, Down's syndrome, or other neurological disorders.

19. A musical translation device system comprising:
a first device comprising:
an input interface;
a first processor;
a first communication interface; and
a first memory communicatively coupled to the first processor and comprising instructions that when executed by the first processor cause the first processor to:
receive a text input at the input interface;
transliterate the text input into a standardized phonemic representation of the text input;
determine, for the phonemic text input, a plurality of spoken pause lengths and a plurality of spoken phoneme lengths;
map the plurality of spoken pause lengths to a respective plurality of sung pause lengths;
map the plurality of spoken phoneme lengths to a respective plurality of sung phoneme lengths;
generate, from the plurality of sung pause lengths and the plurality of sung phoneme lengths, a timed text input; and
transmit, via the first communication interface, message information including the timed text input; and
a second device comprising:
a second processor;
a second communication interface;
a transducer; and
a second memory communicatively coupled to the second processor and comprising instructions that when executed by the second processor cause the second processor to:
receive, at the second communication interface, the timed text input; and
output, by the transducer, a patterned musical message based on the timed text input.

20. A non-transitory computer-readable medium storing thereon sequences of computer-executable instructions for operating a first device, the sequences of computer-executable instructions including instructions that instruct at least one processor to:
receive a text input;
transliterate the text input into a standardized phonemic representation of the text input;
determine, for the phonemic text input, a plurality of spoken pause lengths and a plurality of spoken phoneme lengths;
map the plurality of spoken pause lengths to a respective plurality of sung pause lengths;
map the plurality of spoken phoneme lengths to a respective plurality of sung phoneme lengths;
generate, from the plurality of sung pause lengths and the plurality of sung phoneme lengths, a timed text input; and
transmit, by the first device, message information including the timed text input to a second device such that the second device outputs a patterned musical message indicative of the text input based on the message information.

21. A method of transforming textual input to a musical score comprising:
receiving, by a first device, text input;
mapping the text input to a sung input;
generating, from the sung input, a timed text input; and
transmitting, by the first device, message information including the timed text input to a second device such that the second device outputs a patterned musical message indicative of the text input based on the message information.

22. A method of transforming textual input to a musical score comprising:
receiving, by a first device, text input;
generating, based on the text input, a timed text input;
generating a plurality of matching metrics for each of a respective plurality of portions of the timed text input against a plurality of melody segments;
generating a patterned musical message from the timed text input and the plurality of melody segments based at least in part on the plurality of matching metrics; and
transmitting, by the first device, message information including the timed text input to a second device such that the second device outputs the patterned musical message indicative of the text input based on the message information.
